(19) United States
(12) Patent Application Publication
(10) Pub. No.: US 2024/0386213 A1
(43) Pub. Date: Nov. 21, 2024

(54) System and Method for Autonomous Customer Support Chatbot Agent With Natural Language Workflow Policies

(71) Applicant: Forethought Technologies, Inc., San Francisco, CA (US)

(72) Inventors: Sami Ghoche, San Francisco, CA (US); Deon Nicholas, Millbrae, CA (US); Alan Lu, Santa Clara, CA (US); EJ Liao, Huntington Beach, CA (US); Dev Sharma, San Francisco, CA (US); Antoine Nasr, San Francisco, CA (US); Yi Lu, Bellevue, WA (US); Weitian Xing, Ottawa (CA); Volodymyr Lyubinets, Boynton Beach, FL (US); Jad Chamoun, San Francisco, CA (US); Samy Hajal, San Francisco, CA (US); Sunny Kong, Portland, OR (US); Zachary Tosh, Cerritos, CA (US); James Man, Brisbane, CA (US)

(21) Appl. No.: 18/347,524

(22) Filed: Jul. 5, 2023

Related U.S. Application Data
(63) Continuation-in-part of application No. 17/682,537, filed on Feb. 28, 2022.
(60) Provisional application No. 63/403,054, filed on Sep. 1, 2022.
(60) Provisional application No. 63/484,016, filed on Feb. 9, 2023.
(60) Provisional application No. 63/501,163, filed on May 10, 2023.

(51) Int. Cl. G06F 40/35; G06F 40/44; G06Q 10/10; G06Q 30/015

(52) U.S. Cl. CPC G06F 40/35; G06F 40/44; G06Q 10/10; G06Q 30/015

(57) ABSTRACT

An autonomous customer support Chatbot Agent utilizes a large language model to aid in implementing a workflow to solve a customer issue. A natural language workflow policy may be selected by an admin, along with tools such as API calls. The large language model determines the implementation details for the workflow based on the workflow policy and the selected tools.

### FIELD OF THE INVENTION

The present disclosure generally relates to servicing customer support issues, such as responding to questions or complaints during a lifecycle of a customer support issue.

### BACKGROUND

Customer support service is an important aspect of many businesses. For example, there are a variety of customer support applications to address customer service support issues. As one illustration, a customer service helpdesk may have a set of human agents who use text messages to service customer support issues. There are a variety of Customer Relationship Management (CRM) and helpdesk-related software tools, such as SalesForce® or Zendesk®.

Customer support issues may be assigned a ticket that is served by available human agents over the lifecycle of the ticket. The lifecycle of resolving the customer support issue(s) associated with a ticket may include one or more customer questions and one or more answers made by an agent in response to customer question(s). To address common support questions, the human agents may have available to them macros and templates in SalesForce® or templates in Zendesk® as examples. Macros and templates work well for generating information to respond to routine requests for information, such as if a customer asks, “Do you offer refunds?” However, there are some types of more complicated or non-routine questions for which there may be no macro or template.

Human agents may have available to them other data sources spread across an organization (e.g., Confluence®, WordPress®, Nanorep®, Readmeio®, JIRA®, Guru®, Knowledge Bases, etc.). However, while an institution may have a lot of institutional knowledge to aid human agents, there may be practical difficulties in training agents to use all the institutional knowledge that is potentially available to aid in responding to tickets. For example, conventionally, a human agent may end up doing a manual search of the institutional knowledge. However, an agent may waste time in unproductive searches of the institutional knowledge.

Typically, a human expert makes decisions on how to label and route tickets, which is a resource intensive task. There is also a delay associated with this process because incoming tickets have to wait in a queue for a human expert to make labeling and routing decisions.

However, there are substantial training and labor costs to have a large pool of highly trained human agents available to service customer issues. There are also labor costs associated with having human experts making decisions about how to label and route tickets. But in addition to labor costs, there are other issues in terms of the frustration customers experience if there is a long delay in responding to their queries.

In addition to other issues, it has often been impractical in conventional techniques to have more than a small number of customer issue topics as categories. That is, conventionally tickets are categorized into a small number of categories (e.g., 15) for handling by agents.

### BRIEF DESCRIPTION OF THE DRAWINGS

The present disclosure is illustrated by way of example, and not by way of limitation in the figures of the accompanying drawings in which like reference numerals are used to refer to similar elements.

FIG. 1 is a block diagram illustrating a customer service support environment in accordance with an implementation.

FIG. 2A is a block diagram illustrating a module for using AI to augment customer support agents in accordance with an implementation.

FIG. 2B is a block diagram of a server-based implementation.

FIG. 3 is a block diagram of a portion of a ML system in accordance with an implementation.

FIG. 4 is a flow chart of a method of servicing tickets in accordance with an implementation.

FIG. 5 is a flow chart of a method of automatically generating a templet answer to an incoming question in accordance with an implementation.

FIG. 6 illustrates an example of ML pipeline in accordance with an implementation.

FIG. 7 illustrates aspects of using supervised learning to solve macros in accordance with an implementation.

FIG. 8 is a flow chart of a method of generating macro template answer codes in accordance with an implementation.

FIG. 9 illustrates an example of a method of identifying macro template answers and also initiating a workflow task in accordance with an implementation.

FIG. 10 illustrates an example of a method of training a ML model for triaging the routing of tickets in accordance with an implementation.

FIG. 11 illustrates a method of performing triaging in the routing of tickets in accordance with an implementation.

FIG. 12 illustrates a method of identifying knowledge based articles to respond to a question in accordance with an implementation.

FIG. 13 illustrates a user interface to define a custom intent and support intent workflows in accordance with an implementation.

FIG. 14 illustrates an example of a discovery module having a trained classifier to identify topics of customer support tickets based on a taxonomy in accordance with an implementation.

FIG. 15 is a flow chart of an example method for using the trained classifier in accordance with an implementation.

FIG. 16 is a flow chart of an example method for training a classifier in accordance with an implementation.

FIG. 17 is a flow chart of an example method of filtering noise from ticket data in accordance with an implementation.

FIG. 18 is a flow chart of an example method for generating labels in accordance with an implementation.

FIG. 19 is a flow chart of an example method of training a classifier based on labelled ticket data in accordance with an implementation.

FIG. 20 illustrates an example of performance metrics for predicted topics in accordance with an implementation.

FIG. 21 illustrates an example of a user interface for a pull queue of an agent in accordance with an implementation.

FIG. 22 illustrates an example of a dashboard in accordance with an implementation.

FIG. 23 illustrates a topics user interface in accordance with an implementation.

FIG. 24 illustrates a user interface showing a topic and example tickets.

FIG. 25 illustrates a user interface for building a custom workflow in accordance with an implementation.

FIG. 26 illustrates a user interface for displaying an issue list in accordance with an implementation.

FIG. 27 illustrates the block diagram of FIG. 2A modified to include a workflow engine.

FIG. 28A is a flow chart of a method of automating the generation of template answers or workflows.

FIG. 28B is a flow chart of a method of empathy customization.

FIG. 29A is a flowchart of a method of using generative AI to generate template answers.

FIG. 29B is a flowchart of a method of generating answer with sub-workflows and sub-branches.

FIGS. 30A, 30B, 30C, and 30D illustrate high level methods of program synthesis.

FIGS. 31A, 31B, and 32C are flowcharts of methods of performing program synthesis.

FIG. 32 illustrates functional block for performing empathic customization.

FIG. 33 is a flowchart of a method of empathic customization.

FIGS. 34, 35, 36, 37, and 38 illustrate examples of user interfaces.

FIG. 39 illustrates an example of modules for performing intent detection implementation of workflows for responding to email tickets in accordance with an implementation.

FIG. 40 illustrates examples of models/model training in accordance with an implementation.

FIG. 41A is a flow chart of a method of intent detection implementation of workflows for responding to emails in accordance with an implementation.

FIG. 41B is a flow chart of a method of intent detection implementation of workflows for responding to emails in accordance with an implementation.

FIG. 42 illustrates an example use of an abstractive summarizer to summarize a long email, generate a summary, and use the summary to detect intent in accordance with an implementation.

FIG. 43 illustrates an example of a user interface supporting a handoff to resolve a ticket using interactive chat.

FIG. 44 illustrates an example of a user interface in an interactive chat mode that includes slots for a user to verify and/or insert slot information in accordance with an implementation.

FIG. 45 illustrates an example of a user interface in interactive chate mode resolving a ticket in accordance with an implementation.

FIG. 46A illustrates an example flowchart for forming a workflow for an AI Chatbot by an admin using a step-by-step decision tree in accordance with an implementation.

FIG. 46B illustrates an example user interface for an AI chatbot having step-by-step decision tree for a workflow in accordance with an implementation.

FIG. 47 illustrates a block diagram of an autonomous AI Chatbot interacting with a Large Language Model in accordance with an implementation.

FIG. 48 is a flowchart of a method of implementing a natural language workflow policy for an autonomous AI chatbot in accordance with an implementation.

FIG. 49 is a flowchart illustrating a method of using a natural language workflow policy for a large language model to interact with an autonomous AI chatbot in accordance with an implementation.

FIG. 50 is a flowchart illustrating examples of prompts applied to a large language model used to support an autonomous AI chatbot in accordance with an implementation.

FIG. 51 is an example of a natural language workflow policy in accordance with an implementation.

FIG. 52 illustrates a conversation between a customer and an autonomous AI chatbot implementing the natural language workflow policy of FIG. 51 in accordance with an implementation.

FIG. 53 illustrates examples of AI thought processes associated with the conversation of FIG. 52 in accordance with an implementation.

FIG. 54 is a flowchart of a method of generating a natural language workflow policy in accordance with an implementation.

FIG. 55 is a flowchart of a method of generating a natural language workflow policy in accordance with an implementation.

FIG. 56A is an example of a suggested natural language workflow policy in accordance with an implementation.

FIG. 56B is an example of a suggested natural language workflow policy in accordance with an implementation.

### DETAILED DESCRIPTION

The present disclosure describes systems and methods for aiding human agents to service customer support issues.

### Example System Environment

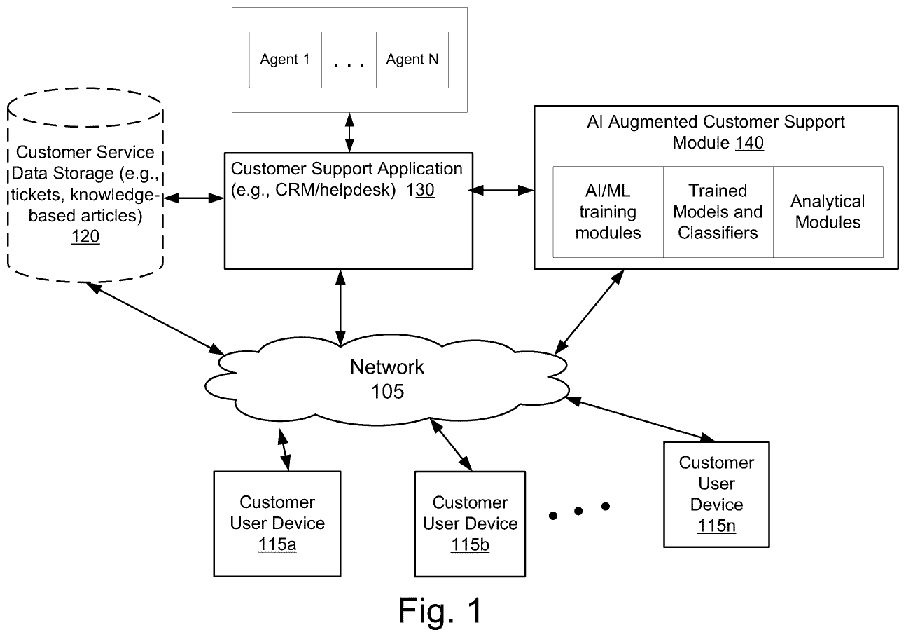

FIG. 1 is a high level block diagram illustrating a customer support environment in accordance with an implementation. The customer support may be provided in a variety of different industries such as support for software applications but more generally be applied to a variety of different industries in which customers have questions that are traditionally answered by human agents. Individual customers have respective customer user devices 115a to 115n that access a network 105, where the network may include the Internet.

A customer support application 130 (e.g., a CRM or a helpdesk) may run on its own server or be implemented on the cloud. The customer support application 130 may, for example, be responsible for receiving customer support queries from individual customer user devices. For example, customer service queries may enter an input queue for routing to individual customer support agents. This may, for example, be implemented using a ticketing paradigm in which a ticket dealing with a customer support issue has at least one question, leading to at least one answer being generated in response during the lifecycle of a ticket. A user interface may, for example, support chat messaging with an agent to resolve a customer support issue, where there may be a pool of agents 1 to N. In a ticketing paradigm, there are Question/Answer pairs for a customer support issue corresponding to questions and corresponding answers.

A database 120 stores customer support data. This may include an archive of historical tickets, that includes the Question/Answer pairs as well as other information associated with the lifecycle of a ticket. The database 120 may also include links or copies of information used by agents to respond to queries, such as knowledge based articles.

An Artificial Intelligence (AI) augmented customer support module 140 may be implemented in different ways, such as being executed on its own server, being operated on the cloud, or executing on a server of the customer support application. The AI augmented customer support module 140 includes at least one machine learning (ML) model to aid in servicing tickets.

During at least an initial setup time, the AI augmented customer support module 140 has access to data storage 120 to access historical customer support data, including historical tickets. The AI augmented customer service module 140 may, for example, have individual AI/ML training modules, trained models and classifiers, and customer service analytical modules. The AI augmented customer service module 140 may, for example, use natural language understanding (NLU) to aid in interpreting customer issues in tickets.

The AI augmented customer support module 140 may support one or more functions, such as 1) automatically solving at least a portion of routine customer service support questions; 2) aiding in automatically routing customer service tickets to individual agents, which may include performing a form of triage in which customer tickets in danger of escalation are identified for special service (e.g., to a manager or someone with training in handling escalations); and 3) assisting human agents to formulate responses to complicated questions by, for example, providing suggestions or examples a human agent may select and/or customize.

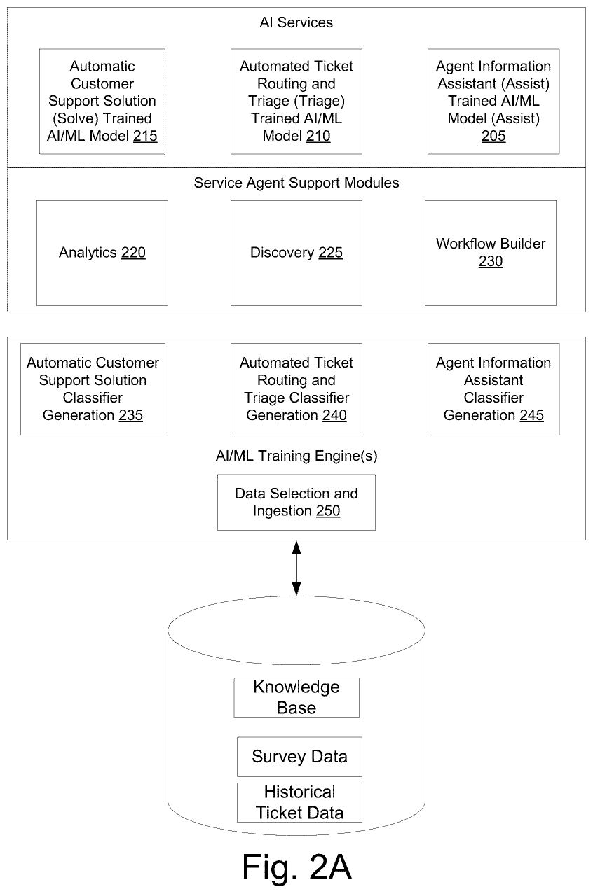

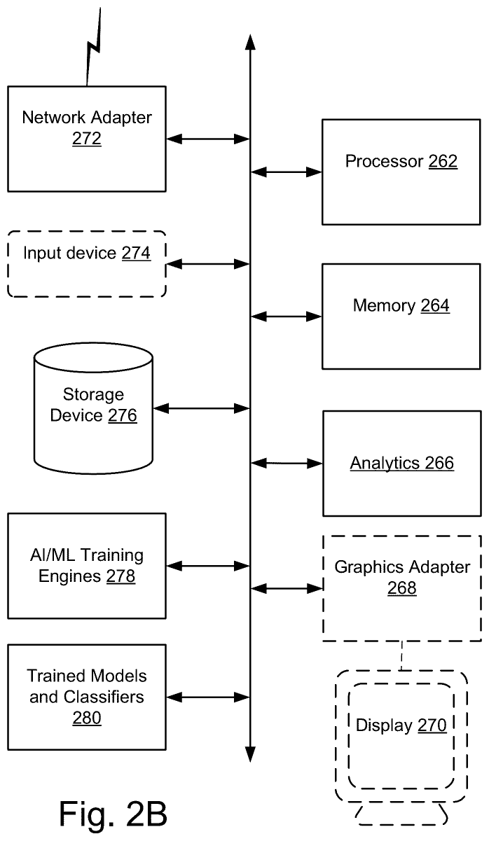

FIG. 2A illustrates an example of functional modules in accordance with an implementation. AI/ML services may include an agent information assistant (an “Assist Module”) 205 to generate information to assist a human agent to respond to a customer question, a ticket routing and triage assistant (a “Triage Module”) 210 to aid in routing tickets to human agents, and an automatic customer support solution module (a “Solve Module”) 215 to automatically generate response solutions for routine questions.

Examples of non-AI services may include an analytics module 220, a discovery module 225, and a workflow builder module 230.

AI/ML training engines may include support for using AL/ML techniques, such as generating labelled data sets or using weakly supervised learning to generate datasets to generate classifiers. The raw data ingested training may include, for example, historical ticket data, survey data, and knowledge base information. A data selection and ingestion module 250 may be provided to select and ingest data. In some implementations, additional functions may include removing confidential information from ingested data to protect data privacy/confidentiality.

Classifiers may be created to predict outcomes based on a feature dataset extracted from incoming tickets. For example, ML/AI techniques may be used to, for example, create a classifier 235 to classify incoming tickets into classes of questions that can be reliably mapped to a pre-approved answer. ML/AI techniques may be used to classify 240 tickets for routing to agents, including identifying a class of incoming tickets having a high likelihood of escalation. ML/AI techniques may also be created to generate 245 information to assist agents, such as generating suggested answers or suggested answer portions.

FIG. 2B illustrates a server-based implementation in which individual components are communicatively coupled to each other. A processor 262, memory 264, network adapter, input device 274, storage device 276, graphics adapter 268, and display 270 may be communicatively coupled by a communication bus. Additional modules may include, for example, computer program instructions stored on memory units to implement analytics functions 266, AI/ML training engines 278, and trained models and classifiers 280.

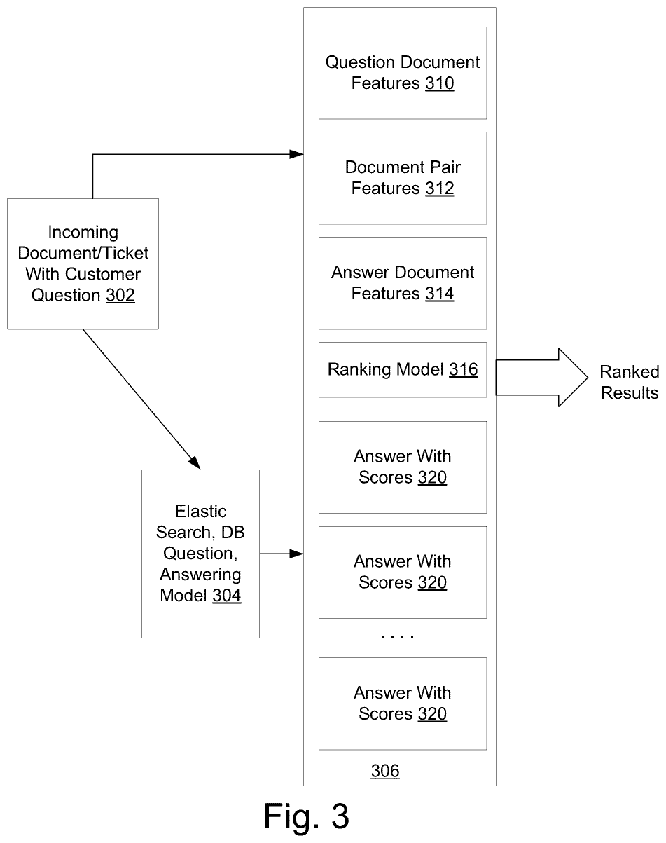

FIG. 3 illustrates an example of a portion of a system 306 in which an incoming ticket 302 is received that has a customer question. The incoming question can be analyzed for question document features 310, document pair features 312, answer document features 314, and can be used to identify answers with scores 320 according to a ranking model 316. For example, an incoming ticket 302 can be analyzed to determine if a solution to a customer question can be automatically responded to using a pre-approved answer within a desired threshold level of accuracy. For more complicated questions, the incoming question can be analyzed to generate suggested possible answers for human agents to consider in formulating an answer to a customer question. Additional analysis may also be performed to identify knowledge articles for agents to service tickets. Additional support may be provided by module 304, which supports elastic search, database questions, and an answering model.

### Example Solve Module

An example of the Solve module is now described regarding automatically generating responses to customer issues. A wide variety of data might be potentially ingested and used to generate automatic responses. This includes a history of tickets and chats and whatever else a company may potentially have regarding CRMs/helpdesks like Zendesk® or Salesforce®. In addition, the ingested data may include stores of any other data sources that a company has for resolving tickets. This may include things like confluence document, Jira, WordPress, etc. This can generally be described in terms of knowledge base documents associated with a history of tickets.

The history of tickets is a valuable resource for training an AI engine to mimic the way human agents respond to common questions. Historical tickets track the lifecycle of responding to a support question. As a result they include a history of the initial question, answers by agents, and chat information associated with the ticket.

Human agents are typically trained to respond to common situations with variations of standard, pre-approved responses. For example, human agents often respond to simple questions about certain classes of software questions by suggesting a user check their browser type or check that they are using the most current version of a software application.

Support managers may, for example, provide human agents with training on suggested, pre-approved answers for commonly asked questions. However, in practice, individual agents may customize the suggested answers, such as making minor tweaks to suggested answers.

The pre-approved answers may, in some cases, be implemented as macros/templates that agents insert into answers and edit to generate answers to common questions. For example, some helpdesk software solutions support an agent clicking a button to apply a macro command that inserts template text in an answer. The agent then slightly modifies the text, such as by filling in fields, making minor tweaks to language, etc.

There are several technical concerns associated with automatically generating responses to common questions using the macros/template a company has to respond to routine questions. The ML model needs to recognize when a customer issue falls into one of a large number of different buckets and respond with the appropriate pre-approved macro/template response with a desired level of accuracy.

In one implementation, an algorithm is used to construct a labeled dataset that allows the problem to be turned into a supervised learning problem. In one implementation, the data associated with historic tickets is ingested. There may, for example, be a list of macros/template answers that is available that is ingested through the CRM. For example, a CRM may support using a larger number, K, of macros. For example, there may be hundreds of macros to generate text for answers. As an example, suppose that K=500 so that there are 500 macros for common questions.

However, while in this example there are 500 macros for common questions, the historic tickets may include numerous variations in macro answers. In one implementation, tickets having answers based on a common macro are identified based on a longest common subsequence. In a longest common subsequence algorithm, subsequent words in the sequence, (though they might not necessarily be consecutive), show up in an order. For example, there might be a word inserted in between two or three words, a word added or removed, etc. This is a form of edit distance algorithm in that an ML algorithm may compare each answer to every single one of the 500 macros in this example of 500 macros. The algorithm may look at the ratio of how long a subsequence is relative to the length of the answer and the length of the macro. Thresholds may be used to assure that there is a high confidence that a particular answer was generated from a particular macro and not from another macro. Another way this can be viewed, is that for a single question in the historic database, a determination is made of which macro the corresponding answer was most likely generated from. Threshold values may be selected so that there is a high confidence level that a given answer was generated by a particular macro rather than from other macros. The threshold value may also be selected to prevent misidentifying custom answers (those not generated from a macro).

Thus, a data set is formed in which a large number of historic tickets have a question and (to a desired threshold of accuracy) have an associated macro answer. Thus, we end up with a supervised learning data set upon which classification can be run. A multi-class model can be run on top of the resulting data set. As an example, a trained model may be based on BERT, XLNet (a BERT-like model), or other transformer-based machine learning techniques for natural language processing pre-training.

Thus, the model may be trained to identify a macro to answer a common question. For example, the trained model may identify the ID of the macro that should be applied. However, a confidence level may be selected to ensure there is a high reliability in selecting an appropriate macro. For example, a threshold accuracy, such as 95%, may be selected. In some implementations, the threshold level of accuracy is adjustable by, for example, a manager.

This is a classification problem in that if a high threshold accuracy is selected, there is more accuracy in the classification, which means that it's more likely the correct macro is selected. However, selecting a high threshold accuracy means that a smaller percentage of incoming tickets can be automatically responded to. In some implementations, a manager or other authorized entity, such as a support administrator, can select or adjust the threshold percentages for prediction.

The classification performed by the trained ML model may be viewed as a form of intent detection in terms of predicting the intent of the user's question, and identifying which bucket the issue in the ticket falls under regarding a macro that can be applied.

### Workflow Builder

In some implementations, a support manager may use an identification of a macro ID to configure specific workflows. For example, suppose that classification of an incoming question returns a macro ID for a refund (a refund macro). In this example, a workflow manager may include a confirmation email to confirm that a customer desires a refund. Or as another example, a macro may automatically generate a customer satisfaction survey to help identify why a refund was requested. More generally, a support manager may support a configurable set of options in response to receiving a macro ID. For example, in response to a refund macro, a confirmation email could be sent to the customer, an email to a client could be sent giving the client options for a refund (e.g., a full refund, a credit for other products or services), a customer satisfaction survey sent, etc.

Thus, in addition to automatically generating macro answers to questions, one or more workflow steps may also be automatically generated for a macro.

### Automatic Identification of Knowledge-Based Information

In some implementations, various approaches may be used to automatically identify appropriate knowledge articles to respond to tickets. This can be performed as part of the Assist Module to aid agents to identify knowledge articles to respond to tickets. However, more generally, automatic identification of knowledge based information may be performed in the Solve Module to automatically generate links to knowledge-based articles, copies of knowledge-based articles, or relevant paragraphs of knowledge based articles as part of an automatically generated answer to a common question.

One way to automatically identify knowledge-based information is to use a form of semantic searching for information retrieval to retrieve knowledge articles from a knowledge database associated with a CRM/helpdesk. However, another way is to perform a form of classification on top of historical tickets to look for answers that contain links to knowledge articles. That is, a knowledge article link can be identified that corresponds to an answer for a question. In effect, an additional form of supervised learning is performed in which there is a data set with questions and corresponding answers with links to a knowledge article. This is a data set that can be used to train a classifier. Thus, in response to an incoming question, a knowledge article that's responsive to the question is identified. The knowledge article can be split into paragraphs and the best paragraph or paragraphs returned. For example, the best paragraph(s) may be returned with word spans highlighted that are likely to be relevant to the question.

The highlighting of text may be based on a BERT model trained on the Stanford Question Answer Dataset (SQUAD). Other various optimizations may be performed in some implementations. One example of an optimization is called tensor RT, which is an Nvidia® hardware optimization.

In some implementations, elastic search techniques, such as BM 25 may be used to generate a ranking or scoring function. As other examples, similarities may be identified based on Google natural questions.

### Example Triage Module

A ticket covers the entire lifecycle of an issue. A dataset of historic tickets would conventionally be manually labelled for routing to agents. For example, a ticket might include fields for category and subcategory. It may also include fields identifying the queue the ticket was sent to. In some cases the agent who answered the ticket may be included. The priority level associated with the ticket may also be included.

In one implementation, the ML system predicts the category and subcategory. The category and subcategory may determine, for example, a department or a subset of agents who can solve a ticket. For example, human agents may have different levels of training and experience. Depending on the labeling system, a priority level can be a particular type of sub-category. An escalation risk can be another example of a type of subcategory that determines who handles the agent. For example, a ticket that is predicted to be an escalation risk may be assigned to a manager or an agent with additional training or experience handling escalations. Depending on the labeling system, there may also be categories or sub-categories for spam (or suspected spam).

The Triage module may auto-tag based on predicted category/sub-category and route issues based on the category/subcategory. The Triage module may be trained on historic ticket data. The historic ticket data has questions and label information on category subcategory, and priority that can be collected as a data set upon which multi class classification models can be trained on using, for example, BERT or XLNet. This produces a probability distribution over all the categories and subcategories. As an illustrative example, if a confidence level (e.g., a threshold percentage) exceeds a selected threshold, the category/subcategory may be sent back to the CRM (e.g., Zendesk® or Salesforce®).

Various optimizations may be performed. One example of an optimization is data augmentation, which may include back translation. In back translation, new examples may be generated by translating back and forth between languages. For example, an English language example may be translated into Chinese and then translated back into English to create a new example. The new example is basically a paraphrasing, and would have the same label. The back translation can be performed more than once. It may also be performed through multiple languages (e.g., English-French-English, English-German-English).

Another optimization for data augmentation includes unsupervised data augmentation. For example, there are augmentation techniques based on minimizing a KL divergence comparison.

The use of data augmentation techniques like back translation means that there is more training data to train models on. Having more training data is useful for dealing with the situation in which there is only limited amount of manually labelled training data. Such a situation may occur, for example, if a company recently changed its taxonomy for categories/subcategories.

One benefit of automating the identification of category/subcategory/priority level is that it facilitates routing. It avoids tickets waiting in a general queue for manual category/subcategory/priority entry of label information by a support agent. It also avoids the expense of manual labeling by a support agent.

The ML model can also be trained to make predictions of escalation, where escalation is the process of passing on tickets from a support agent to more experienced and knowledgeable personnel in the company, such as managers and supervisors, to resolve issues of customers that the previous agent failed to address.

For example, the model may identify an actual escalation in the sense of a ticket needing a manager or a skilled agent to handle the ticket. But more generally, it could identify a level of rising escalation risk (e.g., a risk of rising customer dissatisfaction).

A prediction of escalation can be based on the text of the ticket as well as other parameters, such as how long it's been since an agent answered on a thread, how many agents did a question/ticket cycle through, etc. In some implementations, another source of information for training the ML model to predict the risk of escalation may be based, in part, on customer satisfaction surveys. For example, for every ticket that's resolved, a customer survey may be sent out to the customer asking them to rate the support they received. The customer survey data may be used as a proxy for the risk of an escalation. The escalation model may be based on BERT or XLNet, trained on a secondary data set that is formed from a history of filled out survey data.

### Example Assist Module

In one implementation, the Assist module aids human agents to generate responses. The agents may access macro template answers, the knowledge base of articles, such as WordPress, confluence Google docs, etc. Additionally, in one implementation, the Assist module has a best ticket function to identify a ticket or tickets in the historic database that may be relevant to an incoming question. This best ticket function may be used to provide options for the agent to craft an answer. In one implementation, an answer from a past ticket is identified as a recommended answer to a new incoming ticket so that the support agent can use all or part of the recommended answer and/or revise the recommended answer. In some implementations, a one-click answer functionality is supported for an agent to select a recommended answer.

In one implementation, dense passage retrieval techniques are used to identify a best answer. Dense passage retrieval techniques are described in the paper, Dense Passage Retrieval for Open-Domain Question Answering, Vladimir Karpukhin, Barlas Oğuz, Sewon Min, Patrick Lewis, Ledell Wu, Sergey Edunov, Danqi Chen, Wen-tau Yih, arXiv: 2004.04906 [cs.CL], the contents of which are hereby incorporated by reference. Open-domain question answering relies on efficient passage retrieval to select candidate contexts, where traditional sparse vector space models, such as TF-IDF or BM25, are the de facto method. Embeddings are learned from a small number of questions and passages by a dual-encoder framework.

Some of the problems with identifying a best ticket to generate a suggested possible answer to a question is that there may be a large database of historic tickets from which to select potentially relevant tickets. Additionally, for a given issue (e.g., video conference quality for a video conferencing service), customers can have many variations in the way they word their question. The customer can ask basically the same exact question using very different words. Additionally, different questions may use the same keywords. For example, in a video conferencing application helpdesk, different customer questions may include similar keywords for slightly different issues. The combination of these factors means that traditionally it was hard to use an archive of historic tickets as a resource to answer questions. For example, simplistically using keywords from a ticket to look for relevant tickets in an archive of historic tickets might generate a large number of tickets that may not necessarily be useful for an agent. There are a variety of practical computational problems trying to use old tickets as a resource to aid agents to craft responses. Many techniques of creating a labelled data set would be too computationally expensive or not have other problems in generating useful information for agents.

In one embodiment using a dual encoder framework, there is an encoder for a question, and an encoder for a candidate answer. Each of them produces an embedding. There are outputs and embeddings, there is additional dot product co-sign similarity or a linear layer on top of that as a piece in the middle. Both pieces are trained simultaneously to train an encoder for the question and an encoder for the answer, as well as the layer in-between. There may, for example, be a loss minimization function used in the training.

Each encoder piece is effectively being trained with knowledge of the other encoder piece. So they learn to produce an embedding that's answerable. The embedding is stored in the database. At run time, the model itself is one layer, not a huge number of parameters, and the inputs are embeddings, which are comparatively small in terms of storage and computational resources. This permits candidate answer selection batches to be run in real time with low computational effort.

In other words, embeddings are learned using a dual encoder framework. The training of the encoder may be done so that the dot-product similarities become a good ranking function for retrieval. There is a pre-computing of embeddings, based on training the two encoders jointly so that they are both aware of each other.

### Auto-Suggestion of Answers

In some implementations, an agent is provided with auto-suggestions for at least partially completing a response answer. For example, typing their response, the system suggests a selection of words having a threshold confidence level for a specific completion. This may correspond to a text for the next X words, where X might be between 10, 15, or 20 words, as an example, with the total number of words being selected may be limited to maintain a high confidence level. The auto-suggestion may be based on the history of tickets as an agent is typing their answer. It may also be customized for individual agents. The ML model may, for example, be based on a GPT2 model.

In some implementations, historical tickets are tokenized to put in markers at the beginning of the question, the beginning of the subject of the description, the beginning of the answer, or at any other location where a token may help to identify portions of questions and corresponding portions of an answer. At the end of the whole ticket, additional special markers are placed. The marked tickets are fed into GPT2. The model is trained to generate word prompts based on the entire question as well as anything that the agent has typed so far in their answer.

In some implementations, further customizations may be performed at a company level and/or an agent level. That is, the training can be specific for questions that a company often gets. For example, at company Alpha Bravo, an agent may text: “Thank you for contacting Alpha Bravo. My name is Alan. I'd be happy to assist you.”

Customization can also be performed at an agent level. For example, if at the beginning of the answer, it is agent 7 that is answering, then the agent 7 answer suggestions may be customized based on the way agent 7 uses language.

### 1-Click Agent Assistance

In some implementations, the agent is provided with auto-suggestions that may be implemented by the agent with minimal agent effort to accept a suggestion, e.g., with 1-click as one example. The details of the user answer may be chosen to make suggestions with a high reliability and to make it easy for agents to enter or otherwise approve the suggested answers.

### Analytics Module

The analytics module may support a variety of analytical functions to look at data, filter data, and track performance. This may include generating visualizations on the data, such as metrics about tickets automatically solved, agents given assistance, triage routing performed, etc. Analytics helps to provide an insight into how the ML is helping to service tickets.

### Privacy/Confidentiality Protection

The processing of information from the historic ticket database may be performed to preserve privacy/confidentiality by, for example, removing confidential information from the questions/answers. That is, the method described may be implemented to be compliant with personal data security protection protocols.

### Customer Feedback/Agent Feedback

In some implementations, customers can input feedback (e.g., thumbs up/thumbs down) regarding the support they received in addition to answering surveys. The customer feedback may also be used to aid in optimizing algorithms or as information to aid in determining an escalation risk. Similarly, in some implementations, agents may provide feedback on how useful suggested answers have been to them.

### Discovery Module

In one implementation, a discovery module provides insights to support managers. This may include generating metrics of overall customer satisfaction. In some implementations, a support manager can drill deeper and segment by the type of ticket. Additionally, another aspect is identifying knowledge gaps, or document documentation gaps. For example, some of these categories or subcategories of tickets may never receive a document assigned a high score by the ML model. If so, this may indicate a gap of knowledge articles. As another example, the system may detect similar questions that are not getting solved by macros. In that case, an insight may be generated to create a macro to solve that type of question. In some implementations, the macro may be automatically generated. Such as by picking a representative answer. As an example, in one implementation, there is a clustering of questions and then picking of a representative macro or generating the right macro.

### High Level Flow Chart of Overall Method

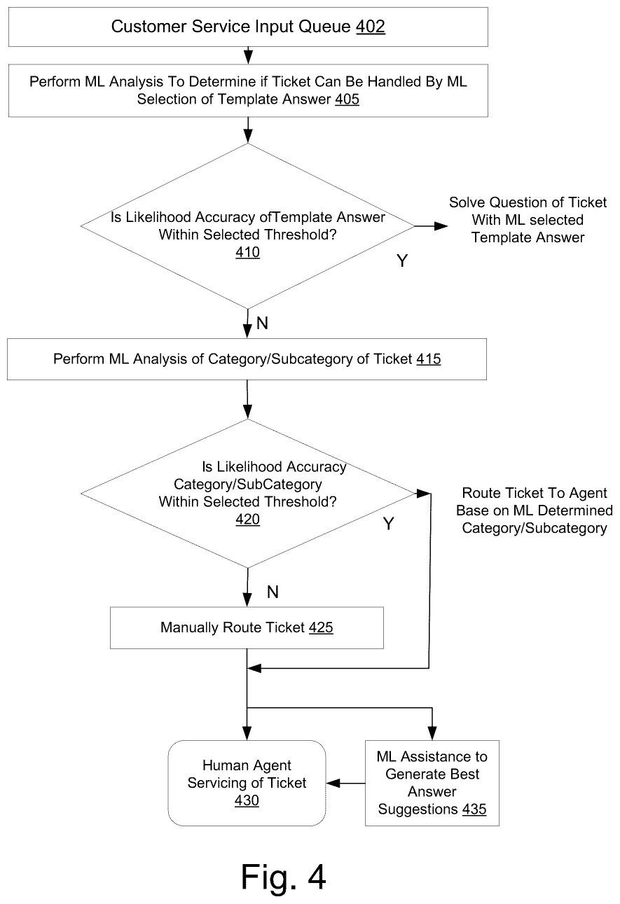

FIG. 4 is a flow chart in accordance to an example. A customer question is received at an input queue in block 402. In block 405, an analysis is performed to determine if a ticket's question can be handled by a ML selection of a template answer.

In decision block 410, a decision is made whether to handle a question with a template answer based on whether a likelihood that a template answer exceeds a selected threshold of accuracy (e.g., above 90%). If the answer is yes, the ticket is solved with an AI/ML selected template answer. If the answer is no, then the question of the ticket is routed to a human agent to resolve.

In block 415, ML analysis is performed of a ticket to identify a category/subcategory for routing a ticket. This may include identifying whether a ticket is likely to be one in which escalation will happen, e.g., predicting a risk of escalation.

In block 420, the likelihood of an accurate category/subcategory determination may be compared with a selected threshold. For example if the accuracy for a category/subcategory/priority exceeds a threshold percentage, the ticket may be routed by category/subcategory/priority. For example, some human agents may have more training or experience handling different issues. Some agents may also have more training or experience dealing with an escalation scenario. If the category/subcategory determination exceeds a desired accuracy, the ticket is automatically routed by the AI/ML determined category/subcategory. If not, the ticket may be manually routed.

In block 430, a human agent services the question of a ticket. However, as illustrated in block 435, additional ML assistance may be provided to generate answer recommendations, suggested answers, or provide knowledge resources to aid an agent to formulate a response (e.g., suggest knowledge articles or paragraphs of knowledge articles).

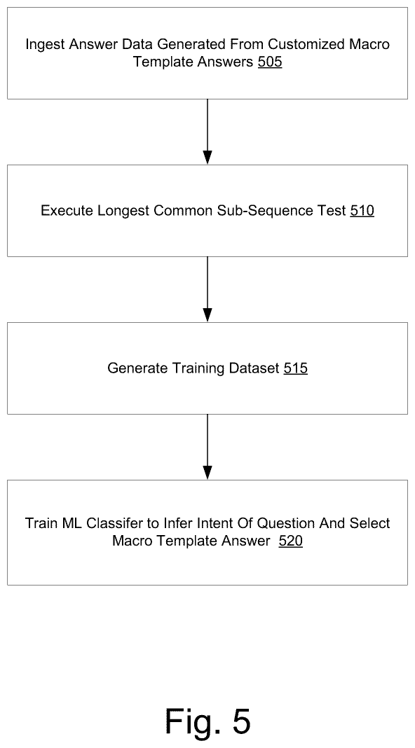

FIG. 5 illustrates a method of determining template answers in accordance with an implementation. In many helpdesk scenarios, human agents are trained to use pre-approved template answer language to address common questions, such as pre-approved phrases and sentences that can be customized. Thus, a collection of historical tickets will have a large number of tickets that include variations of template answer phrases/sentences. In block 505, historic ticket data is ingested, where the historic ticket data includes questions and answers in which at least some of the answers may be based on pre-approved (template) answers. A list of the pre-approved answer language may be provided.

In block 510, a longest common sub-sequence test is performed on the tickets. This permits tickets to be identified that have answers that are a variation of a given macro template answer. More precisely, for a certain fraction of tickets, the ticket answer can be identified as having been likely generated from a particular macro within a desired threshold level of accuracy.

In block 515, a training dataset is generated in which the dataset has questions and associated macro answers identified from the analysis of block 510.

The generated dataset may be used to train a ML classifier to infer intent of a new question and select a macro template answer. That is, a ML classifier can be trained based on questions and answers in the tickets to infer (predict) the user's intention and identify template answers to automatically generate a response.

It should be noted the trained ML classifier doesn't have to automatically respond to all incoming questions. An accuracy level of the prediction may be selected to be a desired high threshold level.

### Additional Flow Charts

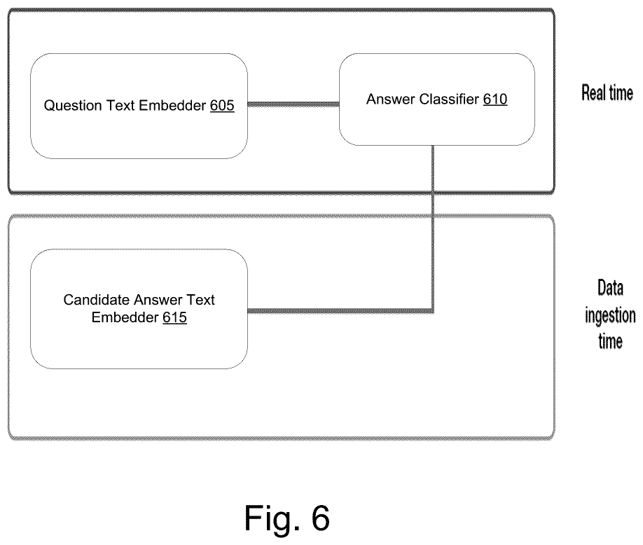

As illustrated in FIG. 6, in one implementation, the ML pipeline may include a question text embedder, a candidate answer text embedder, and an answer classifier. As previously discussed, the training process of question encoders, answer encoders, and embeddings may be performed to facilitate generating candidate answer text in real time to assist agents.

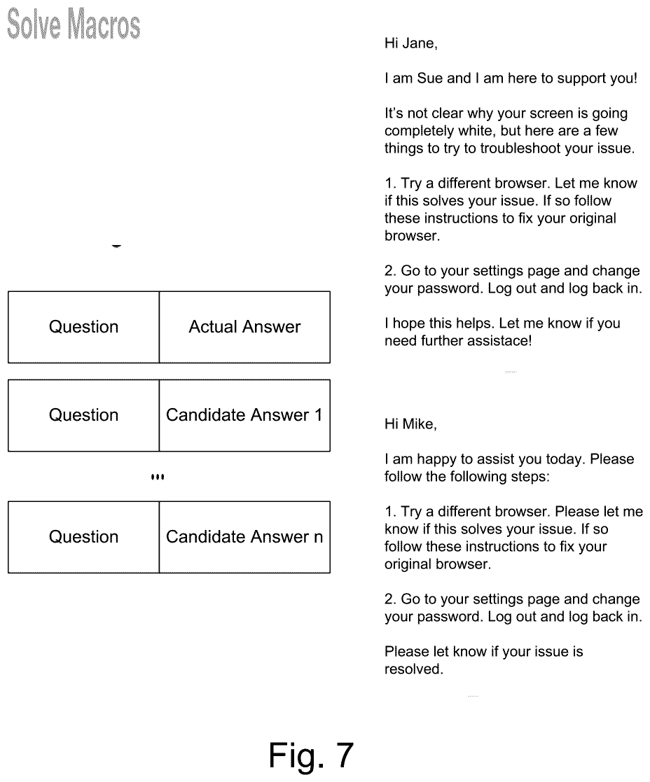

FIG. 7 illustrates an example of how the Solve Module uses weakly supervised learning. On the right are two answers that are variations upon a macro pre-approved answer. In this example, the language for trying a different browser and going to a settings page to change a password are minor variations of each other, with only minor changes, indicative of them having been originally generated from template language. Other portions of the answer are quite different. In any case, a dataset of questions and answers based on macros may be generated and supervised learning techniques used to automatically respond to a variety of common questions.

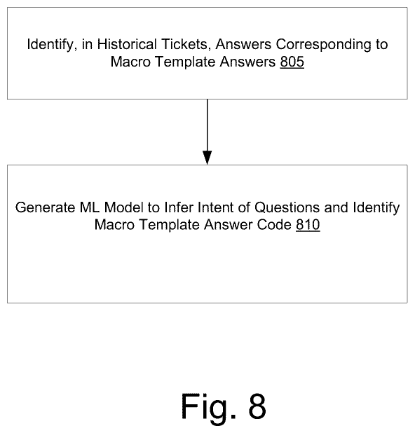

FIG. 8 is a flow chart of a high level method to generate a ML classification model to infer intent of a customer question. In block 805, historical tickets are analyzed. Answers corresponding to variations on template macro answers are identified, such as by using common subsequence analysis techniques. In block 810, supervised learning may be performed to generate a ML model to infer intent of customer question and automatically identify a macro template answer code to respond to a new question.

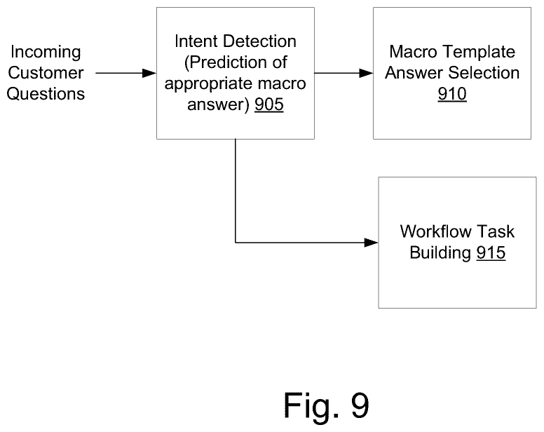

FIG. 9 illustrates a method of automatically selecting a template answer and workflow task building. In block 905, intent is inferred from a question, such as by using a classifier to generate a macro code, which is then used by another answer selection module 910 to generate a response.

For example, a macro code may correspond to a code for generating template text about a refund policy or a confirmation that a refund will be made. In this case, the template answer may be to provide details on requesting a refund or providing a response that refund will be granted. In some implementations, a workflow task building module 915 may use the macro code to trigger a workflow action, such as issuing a customer survey to solicit customer feedback, scheduling follow-up workflow actions, such as scheduling a refund, follow-up call, etc.

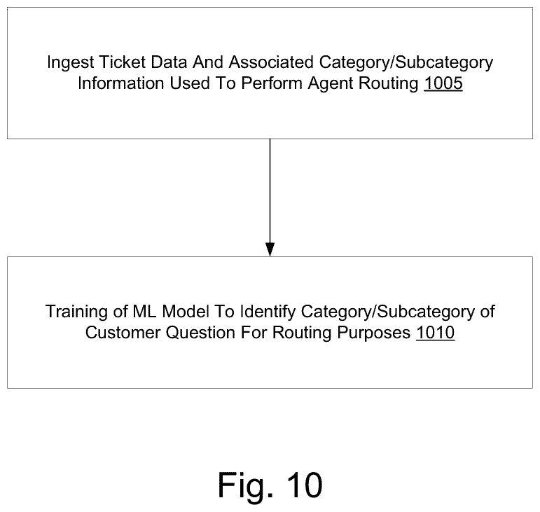

FIG. 10 is a high level flow chart of a method of training a ML classifier model to identify a category/subcategory of a customer question to perform routing of tickets to agents. In block 1005, historic ticket is ingested, which may include manually labelled category/subcategory routing information, as well as a priority level. In block 1010, a ML model is trained to identify category/subcategory of a customer question for routing purposes. This may include, for example, identifying a category/subcategory for identifying an escalation category/subcategory. For example, a customer may be complaining about a repeat problem, or that they want a refund, or that customer service is no good, etc. A ticket corresponding to an escalation risk may be routed to a human agent with training or experience in handling escalation risks. In some implementations, an escalation risk is predicted based in part on other data, such as customer survey data as previously discussed. More generally, escalation risk can be predicted using a model that prioritizes tickets based on past escalations and ticket priority, with customer survey data being still yet another source of data used to train the model.

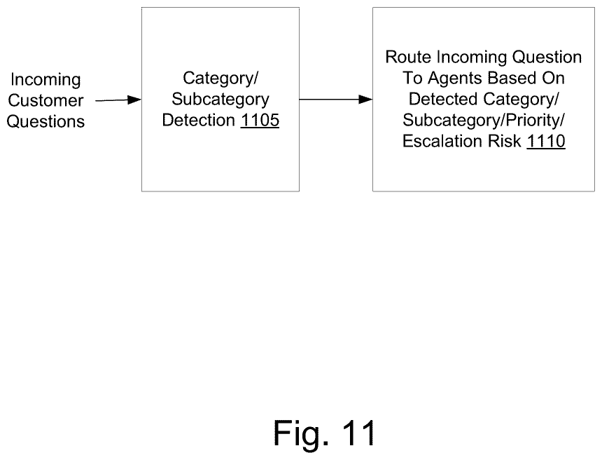

As illustrated in FIG. 11, incoming tickets may be analyzed using the trained ML model to detect category/subcategory/priority in block 1105 and route 1110 a ticket to an agent based on the detected category/subcategory/priority. The routing may, for example, be based in part on the training and skills of human agents. For example, the category/subcategory may indicate that some agents are more capable of handling the question than other agents. For example, if there is indication of an escalation risk, the ticket may be routed to an agent with training and/or experience to handle escalation risk, such as a manager or a supervisor.

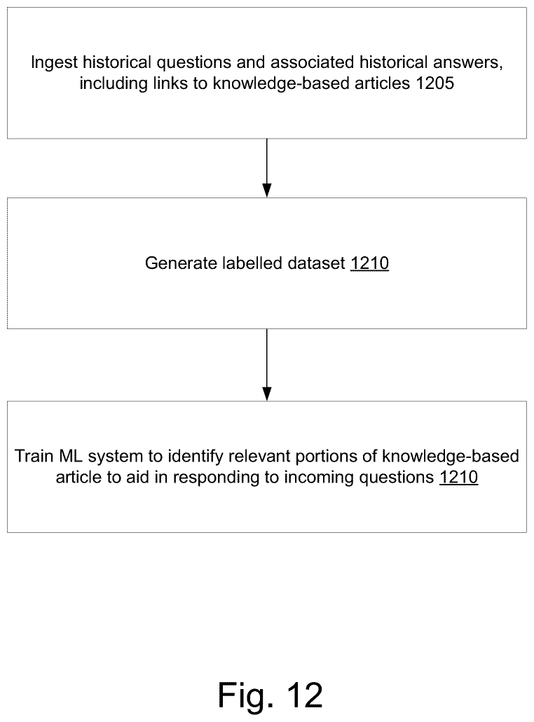

FIG. 12 is a flow chart of a method of training a ML model to generate a ML classifier. In block 1205, historical questions and historical answers are ingested, including links to a knowledge based article. In block 1210, a labelled dataset is generated. In block 1215, the ML is trained to generate answers to incoming questions, which may include identifying relevant portions of knowledge based answers.

### Additional Examples of Intent Detection for Solve Module and Workflows

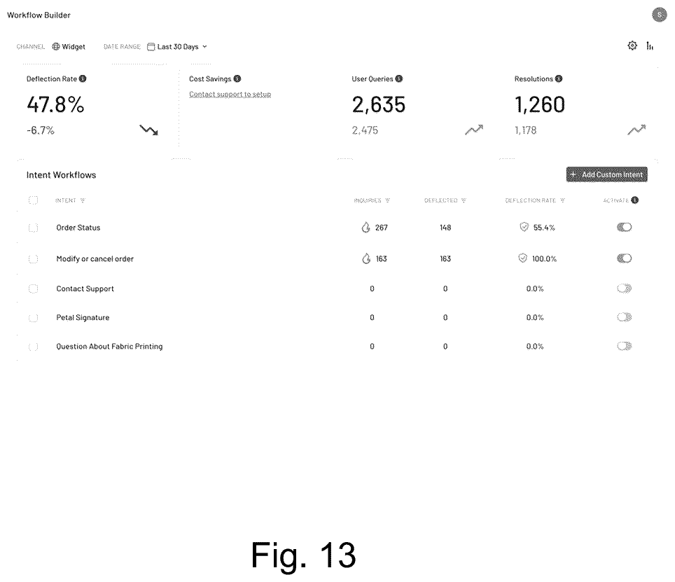

Referring to FIG. 13, in one implementation, custom intents can be defined and intent workflows created in a workflow builder. In the example of FIG. 13, intent workflows are illustrated for order status, modify or cancer order, contact support, petal signature, question, and question about fabric printing. But more generally, custom intent workflows may be defined using the workflow builder, which is an extension of the Solve module.

As previously discussed, In some implementations, a support manager may configure specific workflows. In one implementation, a support manager can configure workflows in Solve, where each workflow corresponds to a custom “intent.” An example of an intent is a refund request, or a reset password request, or a very granular intent such as a very specific customer question. These intents can be defined by the support admin/manager, who also configures the steps that the Solve module should perform to handle each intent. The group of steps that handle a specific intent are called a workflow. When a customer query comes in, determine with a high degree of accuracy which intent (if any) this query corresponds to, and if there is one, triggers the corresponding workflow (i.e., a sequence of steps).

### Automatic Generation of Granular Taxonomy

Conventionally, a company manually selects a taxonomy for categories/subcategories in regards to ticket topics of a customer support system. This typically results in a modest number of categories/categories, often no more than 15. Manually selecting more than about 20 categories also raises challenges training support agents to recognize and accurately label every incoming ticket.

In one implementation, the discovery module 225 includes a classifier trained to identify a granular taxonomy of issues customers are contacting a company about. The taxonomy corresponds to a set of the topics of customer issues.

As an illustrative example, customer support tickets may be ingested and used to identify a granular taxonomy. The total number of ingested customer support tickets may, for example, correspond to a sample size statistically likely to include a wide range of examples of different customer support issues (e.g., 50,000 to 10,000,000 customer supported tickets). This may, for example, correspond to ingesting support tickets over a certain number of months (e.g., one month, 3 months, six months, etc.). There is a tradeoff between recency (ingesting recent tickets to adapt the taxonomy to new customer issues), the total number of ingested support tickets (which is a factor in the number of taxonomy topics that are likely to be generated in the taxonomy), and other factors (e.g., the number of different products, product versions, software features, etc. of a company). But as an illustrative example, a granular taxonomy may be generated with 20 or more topics corresponding to different customer support issue categories. In some cases the granular taxonomy may be generated with 50 or more topics. In some cases, the granular taxonomy may include up to 200 or more different issue categories.

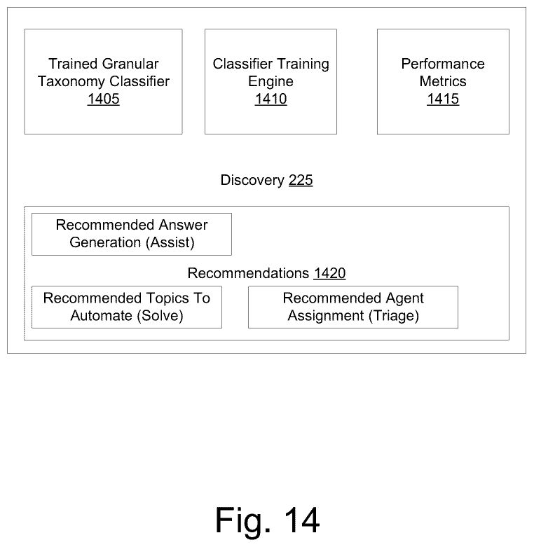

Referring to FIG. 14, in one implementation the discovery module includes a trained granular taxonomy classifier 1405. A classifier training engine 1410 may be provided to train/retrain the granular taxonomy classifier. In some implementations, the granular taxonomy classifier 1405 is frequently retrained to aid in identifying new emerging customer support issues. For example, the retraining could be done on a quarterly basis, a monthly basis, a weekly basis, a daily basis, or even on demand.

A performance metrics module 1415 may be provided to generate various metrics based on a granular analysis of the topics in customer support tickets, as will be discussed below in more detail. Some examples of performance metrics include CSAT, time to resolution, time to first response, etc. For example, the performance metrics may be used to generate a user interface (UI) to display customer support issue topics and associated performance metrics. Providing information at a granular level on customer support issue topics and associated performance metrics provides valuable intelligence to customer support managers. For example, trends in the performance metrics of different topics may provide actionable clues and suggest actions. For example, a topic indicating a particular problem with a product release may emerge after the product release and an increase in the percentage or volume of such ticket may generate a customer support issue for which an action step could be performed, such as alerting product teams, training human agents on how to handle such tickets, generating recommended answers for agents, or automating responses to such tickets.

A recommendations module 1420 may be provided to generate various types of recommendations based on the granular taxonomy. As some examples, recommendations may be generated on recommended answers to be provided to agents handling specific topics in the granular taxonomy. For example, previous answers given by agents for a topic in the granular taxonomy may be used to generate a recommended answer when an incoming customer support ticket is handled by an agent. Recommendations of topics to be automatically answered may be provided. For example, the granular taxonomy may be used to identify topics that were not previously provided with automated answers. Recommendations may also be provided to consider updating the assignment of agents to topics when new topics are identified.

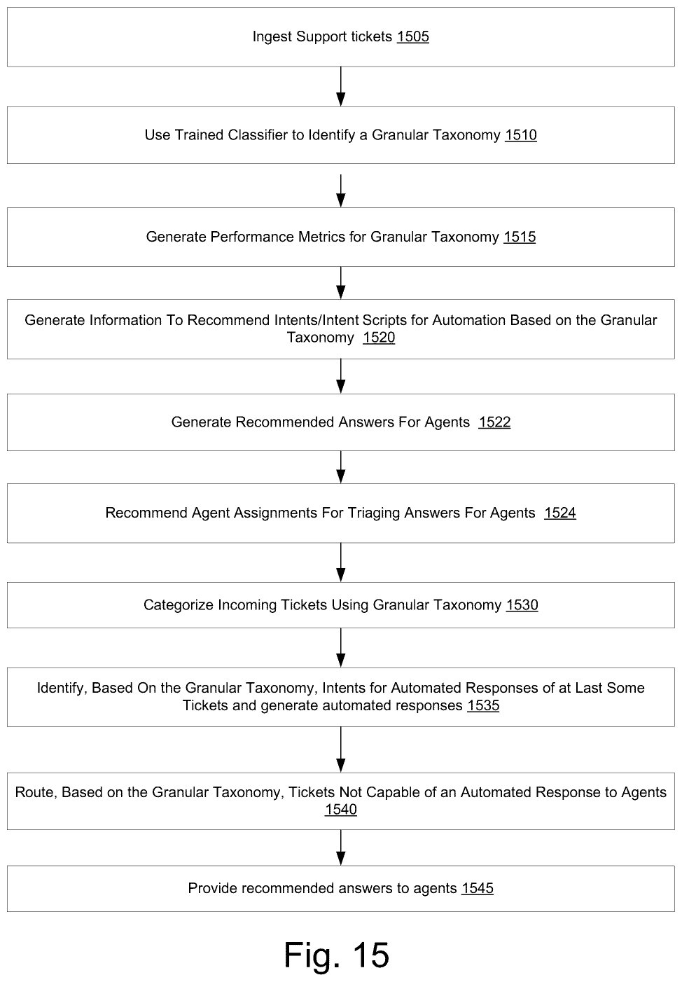

FIG. 15 is a flow chart of an example method of using the trained classifier in accordance with an implementation. In block 1505, support tickets are ingested. As in this example, the classifier has been previously trained, in block 1410 it's used to identify and classify customer support tickets in regards to individual tickets having a topic in the granular taxonomy (e.g., for example, 50 to 200 or more topics). The classification may be against a set of thresholds, e.g., a positive classification made for a value exceeding a threshold value corresponding to a pre-selected confidence value.

As an implementation detail, the order of some of the following steps may vary from that illustrated. However, as an illustrative example, in block 151, performance metrics are generated based on the granular taxonomy. For example, if the granular taxonomy has 200 or more topics, statistics and performance metrics may be calculated for each topic and optionally displayed in a UI or in a dashboard. The statistics and performance metrics may also be used in a variety of different ways.

In block 1520, information is generated to recommend intents/intent scripts based on the granular taxonomy. As one of many possibilities, a dashboard may display statistics or performance metrics on topics not yet set up to generate automatic responses (e.g., using the Solve module). Information may be generated indicating which topics are the highest priority for generating scripts for automatic responses.

Another possibility, as illustrated in block 1522 is to generate a recommended answer for agents. The generation of recommended answers could be done in a setup-phase. For example, when an agent handles a ticket for a particular topic, based on previous agent answers for the same topic may be provided using, for example, the Assist module. Alternatively, recommended answers could be generated on demand in response to an examiner handling a customer support ticket for a particular topic.

In some implementations, a manager (or other responsible person) may be provided with a user interface to permit them to assign particular agents to handle customer support tickets for particular topics. Information on customer support topics may be used to identify agents to handle particular topics. For example, if a new topic corresponds to customers having problems with using a particular software application or social media application on a new computer, a decision could be made to assign that topic to a queue handled by an agent having relevant expertise. As another example, if customer support tickets for a particular topic generated particularly have bad CSAT scores, that topic could be assigned to more experienced agents. Having granular information on customer support ticket topics, statistics, and performance metrics permits a better assignment to be made of agents to handle particular topics. In some implementations, a manager (or other responsible person) could manually assign agents to particular topics using a user interface. However, referring to block 1524, alternatively, a user interface could recommend assignment for particular topics based on factors such as the CSAT scores or other metrics for particular topics.

Blocks 1530, 1535, 1540, and 1545 deal with responding to incoming customer support tickets using the granular taxonomy. In block 1530, incoming tickets are categorized using the granular taxonomy. For example, the trained classifier may have pre-selected thresholds for classifying an incoming customer support ticket into a particular topic of the taxonomy. As illustrated in block 1535, the intents of at least some individual tickets are determined based on the topic of the ticket, and automated responses are generated.

As illustrated in block 1540, remaining tickets may be routed to individual agents. In some implementations, at least some of these tickets may be routed to agents based on topic. For example, some agents may handle tickets for certain types of tickets based on subject matter experience or other factors. In block 1545, recommended answers are provided to individual agents based on previous answers to tickets for the same topic. The recommended answers may be generated in different ways. For example, they may be generated based on the text of previous answers. For example, a model may generate a recommended response based on the text of all the agent answers in previous tickets. Alternatively, an algorithm could be used to pick a previous answer to a topic that is most likely to be representative. For example, answers to particular topics may be represented in a higher dimensional space. Tickets most like each other (close together in a higher dimensional space) may be deemed to be representative.

The training of the classifier will now be described. Manual (human) labelling of tickets is theoretically possible but is time consuming, costly, and complicated when there is a large number of known topics. However, one of the issues in generating a granular taxonomy is that the taxonomy needs to be discovered as part of the process of training the classifier. Customer support tickets may include emails, chats, and other information that is unstructured text generated asynchronously. For example, a customer support chat UI may include a general subject field and unstructured text field for a customer to enter their question and initiate a chat with an agent. An individual customer support ticket may be comparatively long in the sense of having rambling run on sentences (or voice turned into text for a phone interaction) before the customer gets to the point. An angry customer seeking support may even rant before getting to the point. An individual ticket may ramble and have a lot of irrelevant content. It may also have repetitive or redundant content.

Additionally, in some cases, a portion of a customer support ticket may include template language or automatically generates language that is irrelevant for generating information to train the classifier. For example, the sequence of interactions in a customer support ticket may include template language or automatically generated language (e.g., as an example an agent may suggest a template answer to a customer (e.g., “Did you try rebooting your computer?) with each agent using slight variations in language (e.g., “Hi Dolores. Have you tried rebooting your computer?”). However, this template answer might not work, and there may be other interactions with the customer before the customer's issue is resolved. As another example, an automated response may be provided to a customer (e.g., “Have you checked that you upgraded to at least version 4.1?”). However, if the automated response fails, there may be more interactions with the client.

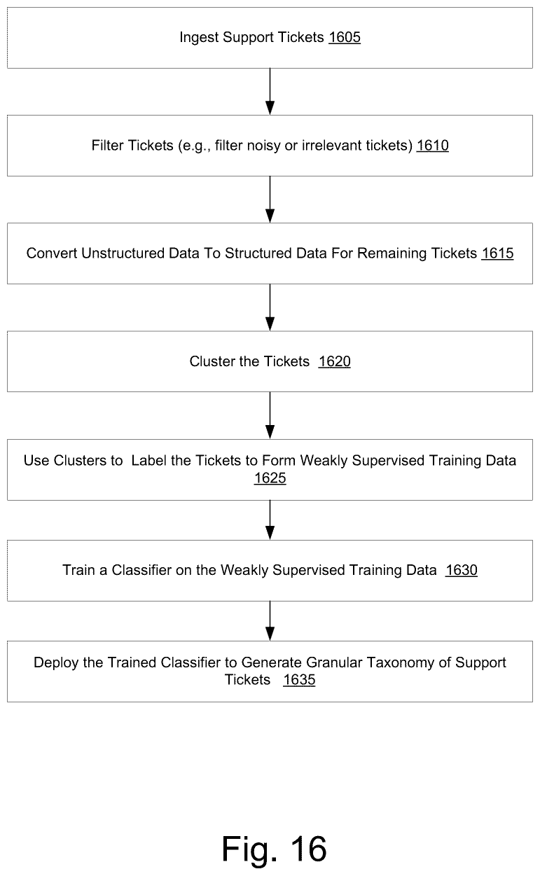

FIG. 16 is a flow chart of an example method of training the classifier according to an implementation. In block 1605, support tickets are ingested. As previously discussed this may be a selected number of support tickets. In block 1610 the ingested support tickets are filtered. The filtering may filter noisy portions of ticket or otherwise filter irrelevant tickets. This may include filtering out template answers and automated sections of tickets. More generally, the filtering may include other types of filtering to filter out text that is noise or otherwise irrelevant for later analysis.

In block 1615, the unstructured data of each ticket is converted to structured (or at least semi-structured) data. For example, one or more rules may be applying to structure the data of the remaining tickets. For example, individual customers may use different word orders and different words for the same problem. An individual customer may use different length sentences to describe the same product and problem, with some customers using long rambling run-on sentences. The conversion of the unstructured text data to structured text data may also identify the portion of the text most likely to be the customer's problem. Thus, for example, a long rambling unstructured rant by a customer may be converted into structured data identifying the most likely real problem the customer had. A rule may be applied to identify and standardize the manner in which a subject, or a short description, or a summary is presented.

Applying one or more structuring rules to the ticket data results in greater standardization and uniformity in the use of language, format, and length of ticket data for each ticket, which facilitates later clustering of the tickets. This conversion of the unstructured text data into structured text may use any known algorithm, model, or machine learning technique to convert unstructured text into structured (or semi-structured) text that can be clustered in the later clustering step of the process.

In block 1620, the ticket data that was structured data is clustered. The clustering algorithm may include a rule or an algorithm to assign a text description to the cluster. The clusters are used to label the customer support tickets and generate training data to train the classifier. This corresponds to training the classifier on weakly supervised training data.

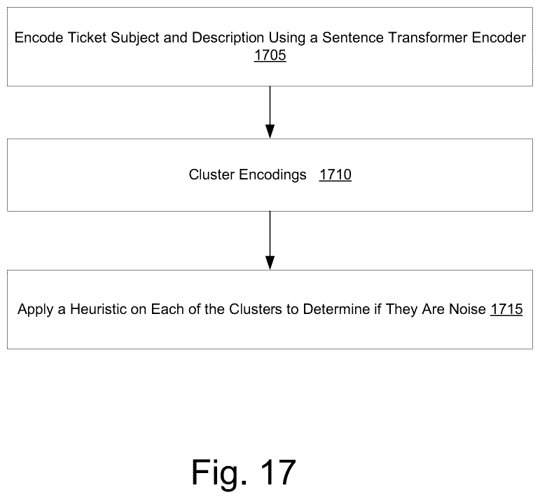

FIG. 17 is a flow chart of an example method of filtering to filter out noise and irrelevant text, which may include text from template answers and automated answers. In block 1705, the ticket subject and description are encoded using a sentence transformer encoder. In block 1710, the encodings are clustered. For example a DBSCAN (Density based Spatial Clustering Of Applications With Noise) may be used. In block 1715, a heuristic is applied on the clusters to determine if they are noise. For example, a heuristic may determine if more than a pre-selected percentage of the text is overlapping between all the pairs of tickets in the cluster. A high percentage (e.g., over 70%) may be indicative of noise (e.g., text generated from a common template answer). However, other heuristic rules could be applied. The noisy clusters are then removed. That is, the end result of the filtering process may include removing tickets data corresponding to the noisy clusters.

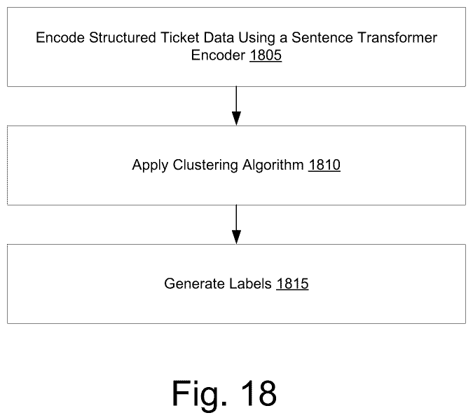

A variety of clustering techniques may be used to perform the step 1620 of clustering the tickets in FIG. 16. The may include a variety of different clustering algorithms, such as k-means clustering. Another option is agglomerative clustering to create a hierarchy of clusters. In one implementation, DBSCAN is used to perform step 1620. Referring to the flow chart of FIG. 18, in one implementation, in block 1805, the structured ticket data is encoded using a sentence transformer. In block 1810, a clustering algorithm is applied, such as DBSCAN. The name of the cluster may be based on a most common summary generated for that cluster. A variety of optimizations may optionally be performed. For example, some of the same issues may be initially clustered in separate but similar clusters. A merger process may be performed to merge similar clusters, such as by performing another run of DBSCAN with looser distance parameter and mering clusters together to obtain a final clustering/labeling.

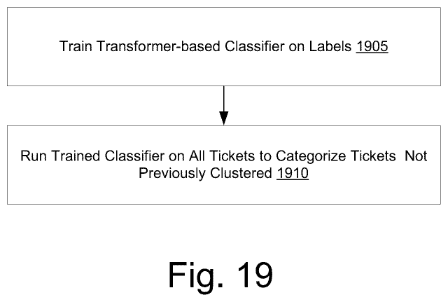

FIG. 19 is a flow chart illustrating in block 1905 training the transform based on labels generated from the clustering process. The classifier may be a transformer based classifier, such as ROBERTA or XLNet. In block 1910, the classifier is run on all tickets to categorize at least some of the tickets that were not successfully clustered.

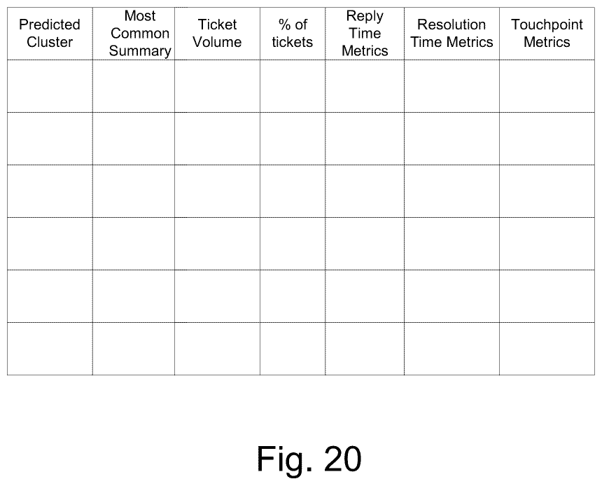

A variety of dashboards and UIs may be supported. FIG. 20 illustrates an example of performance metric fields. Each topic may correspond to a predicted cluster. Summary information, ticket volume information, % of tickets, reply time metrics, resolution time metrics, and touchpoint metrics are examples of the types of performance metrics that may be provided.

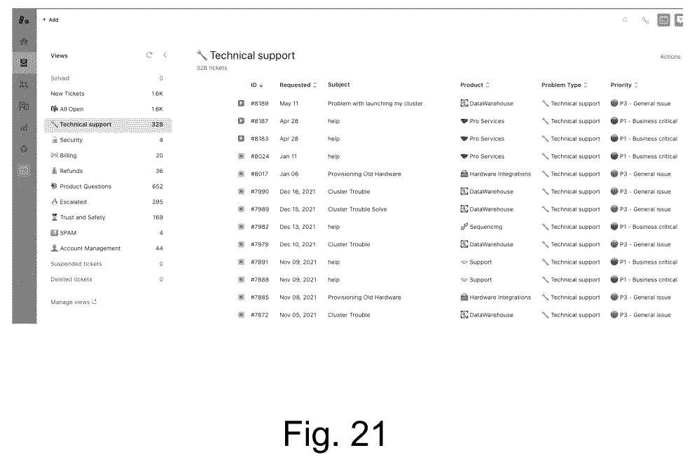

FIG. 21 illustrates a pull queue UI in which agents may pull tickets based on subject, product, problem type, and priority (e.g. P1, P2, P3). Agents may be instructed to pick up tickets in specific queues. Push (not shown) occurs when tickets are assigned to agents through an API based on factors such as an agent's skills, experience, and previous tickets they have resolved.

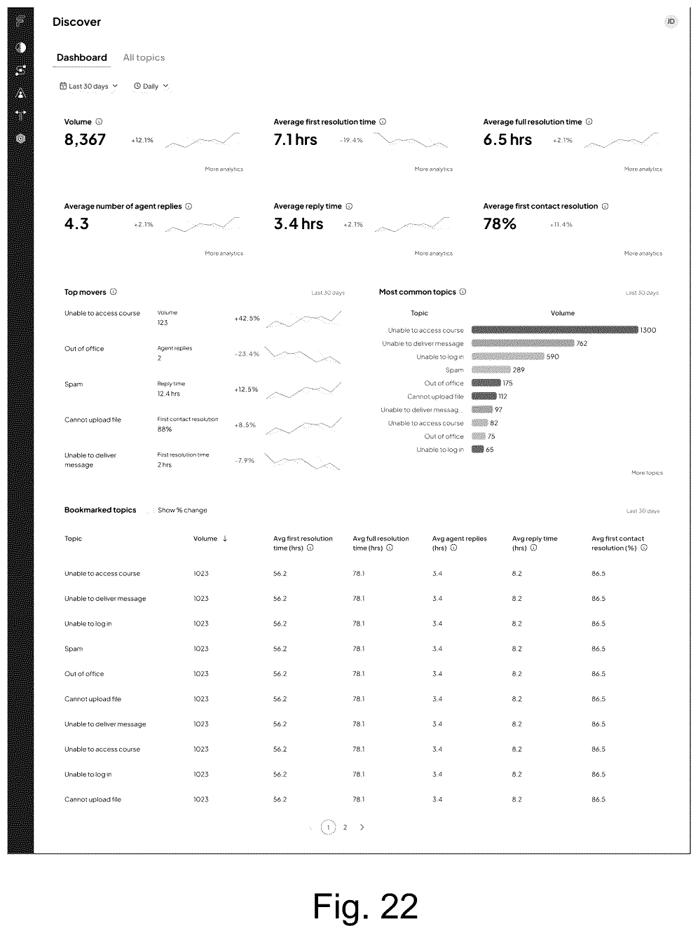

FIG. 22 illustrates a dashboard. The dashboard in this example shows statistics and metrics regarding tickets, such as ticket volume, average number of agent replies, average first resolution time, average reply time, average full resolution time, and average first contact resolution. As other examples, the dashboard may show top movers in terms of ticket topics (e.g., “unable to access course”, “out of office”, “spam”, “cannot upload file”, etc.). As another example, bar chart or other graph of most common topics may be displayed. As still yet another example, bookmarked topics may be displayed.

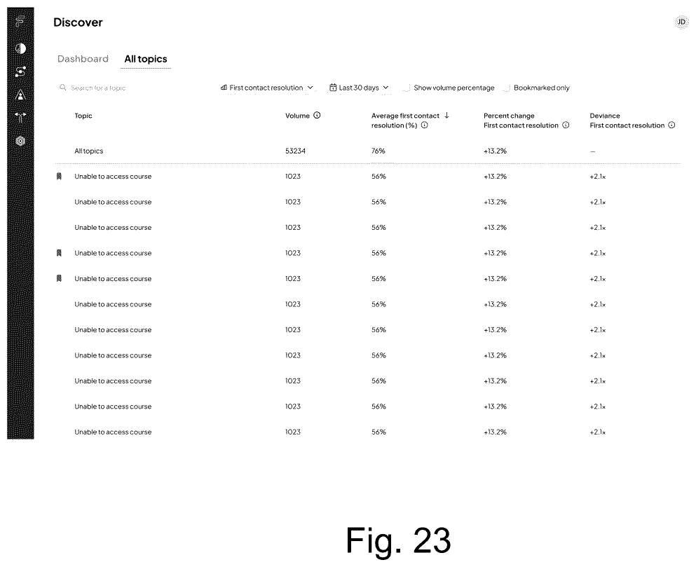

FIG. 23 shows a UI display a list of all topics and metrics such as volume, average first contact resolution, percent change resolution, percent change first contact resolution, and deviance first contact resolution.

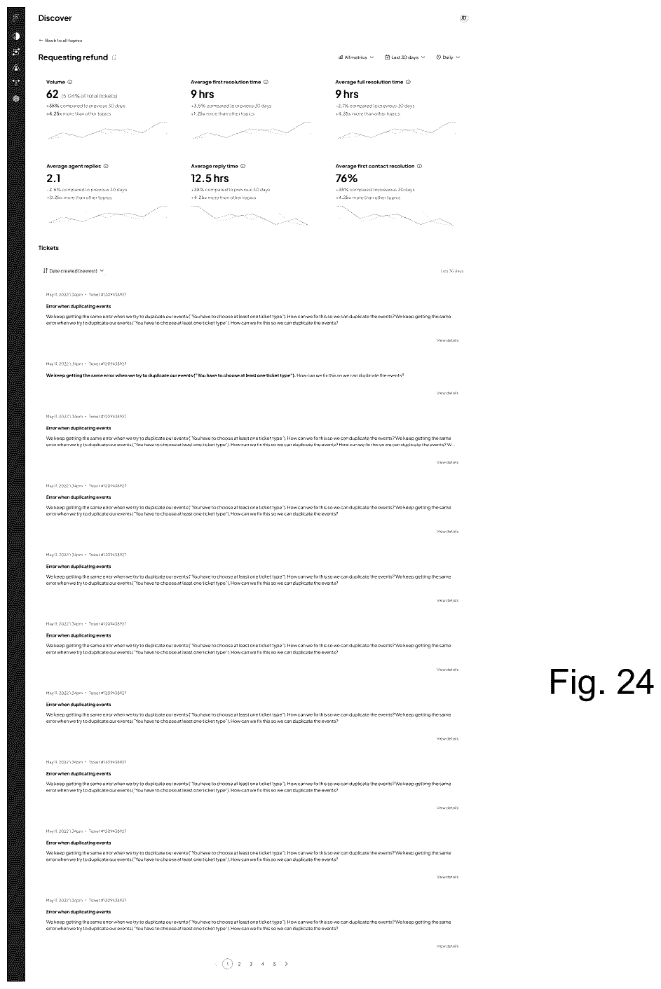

FIG. 24 illustrates a UI showing metrics for a particular topic (e.g., “requesting refund”). Information on example tickets for particular topics may also be displayed.

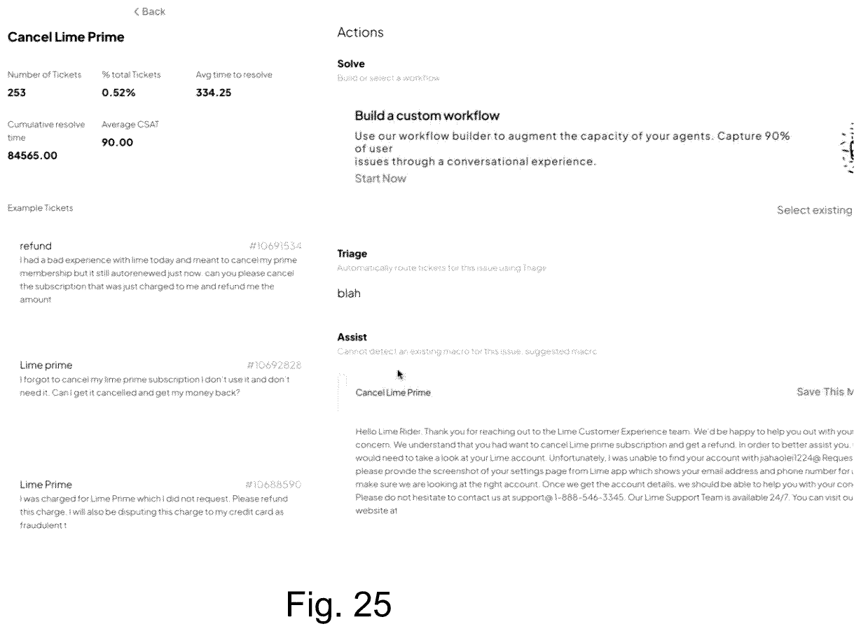

FIG. 25 illustrates a UI having an actions section to build a custom workflow for solve, customizing triage, and generating suggested answers for assist.

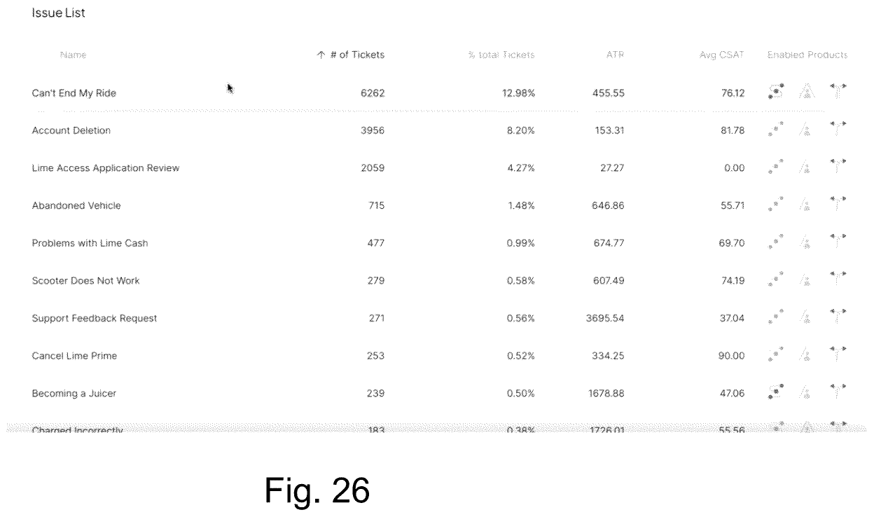

FIG. 26 shows a UI having an issue list and metrics such as number of tickets, percentage of total tickets, average time to response, and average CSAT.

While several examples of labeling have been described, more generally multi-labels could also be used for the situation of tickets representing multiple issues.

In some implementations, periodicity retraining of the classifier is performed to aid in picking up on dynamic trends.

While some user interfaces have been described more generally, other user interfaces could be included to support automation of the process of going from topics to determining intents from the topics to automating aspects of providing customer support.

### Workflow Engine Examples

Large language models (LLMs) can be used to aid in providing customer support. Generative AI models, such as ChatGPT may be used. However conventional generative AI models are trained to generate a plausible sounding answer that mimics language. Significant modifications are necessary to use them to aid in providing customer support. For example, in customer support, context about a customer inquiry is important in order to respond correctly. An understanding of the decision-logic for customer support is important. Domain relevance is also important. For example, to correctly respond to a customer inquiry about a refund or an order status for a specific business may require understanding context about an inquiry, understanding decision logic, and understanding domain-relevance.

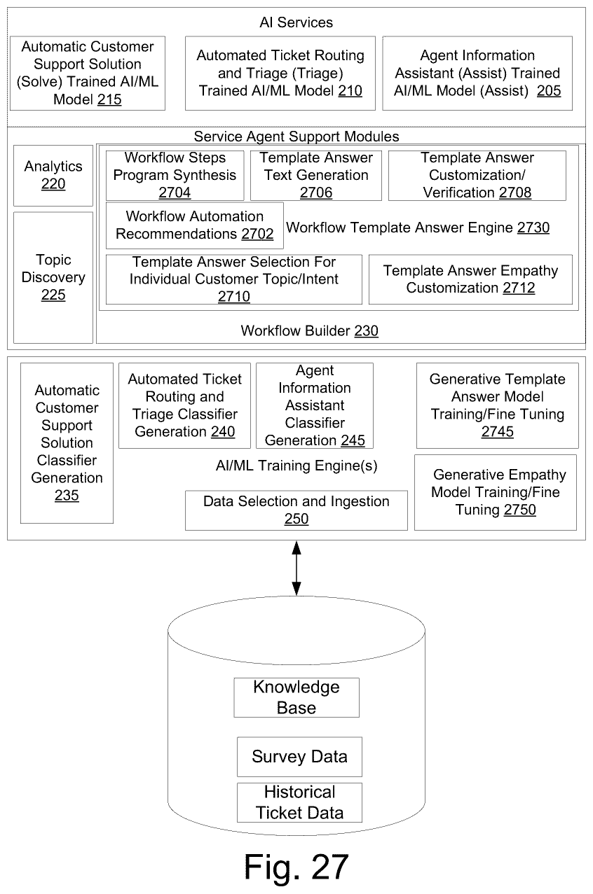

FIG. 27 is a variation of the example of FIG. 2A with examples of different modules to automatically generate workflow template answers. In one implementation, the workflow builder 230 includes a workflow template answer engine 2730. In one implementation, the workflow template answer engine 2730 includes a workflow automation recommendations module 2702 to generate recommendations for workflows to be automated. For example, in one implementation this may include identifying topics for which a workflow has not yet been automated. This may include, for example, determining potential cost savings for automating the generation of workflows for one or more topics. In one implementation, a template answer text generation module 2706 generates suggested template text for responding to specific topics. For example, for a topic corresponding to a customer request for a refund, the template text may be generated based on the monitored text answers agents use to respond to the topic.

In one implementation, a workflow steps program synthesis module 2704 generates workflow steps. A workflow step may, for example, include a message step or a network call having an API call step. A message step may correspond to a text message sent to a customer. An API call step may correspond to an agent triggering API calls using button clicks to implement a network call.

While it is desirable that program synthesis completely automate workflow steps, it should be noted that even generating a skeleton of the workflow can be useful to minimize the work of an administrator. To the extent that any parameters passed into a network call are missing from the context variable defined in workflow, the missing parameters can be left as placeholders to be filled out in a generated workflow. For example, placeholders can be filed out by form steps, such as asking the end customer to input missing information, or through another API call step that pulls information from another system.

Similarly, while its desirable to automatically generate the text message for an automated answer, even providing an administrator with option of suggested text for them to select/edit may be used to reduce the labor required to automate generating an answer.

Reducing the labor for an administrator to create an automated text response and a corresponding workflow aid in automating workflows. In one implementation, a template answer customization/verification module 2708 permits a supervisor to verify or customize suggested text for a template answer. In one implementation, the template answer customization/verification module 2708 permits a supervisor to enter workflow steps for an answer, verify suggested workflow steps, or customize workflow steps. As one example, a supervisor could be provided with one or more options for a text response to a particular topic. As another example, a supervisor could be provided with options for implementing a workflow. That is, even providing a skeleton framework or a set of options for an administrator reduces the time requires for an administrator to implement a workflow even if complete program synthesis is not always possible. Providing recommended text or text options provides a benefit. Provides at least a skeleton framework for a workflow provides a benefit. Providing a largely or completely complete text response and workflow steps provides is even better.

In one implementation, a template answer selection module 2710 is provided to select a template answer (and any available workflow) for a customer question corresponding to a particular topic or intent. A template answer empathy customization module 2712 may be used to customize and a template answer for empathy, such as by adding an empathic sentence to a substantive answer. For example, if a customer's question is in regard to canceling a service subscription of their son because their son died, an empathic answer could be generated (e.g., “I'm sorry to hear that your son died” that is added to a substantive portion of the answer “I can help you cancel the service subscription”).

Additional support modules may include a generative AI template answer model training/fine tuning module 2745 to train and tune a generative template answer model. As an illustrative example, a generative AI model such as T5, GPT-Neo, or OPT may be trained and finetunes on the task of generating a template answer given a prompt of many similar (real) answers. A generative AI empathy model training/fine tuning module 2750 may be provided to train/fine tune a an empathy model.

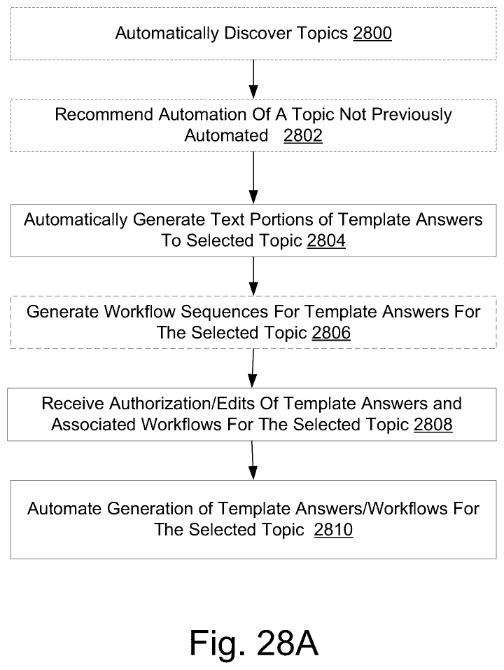

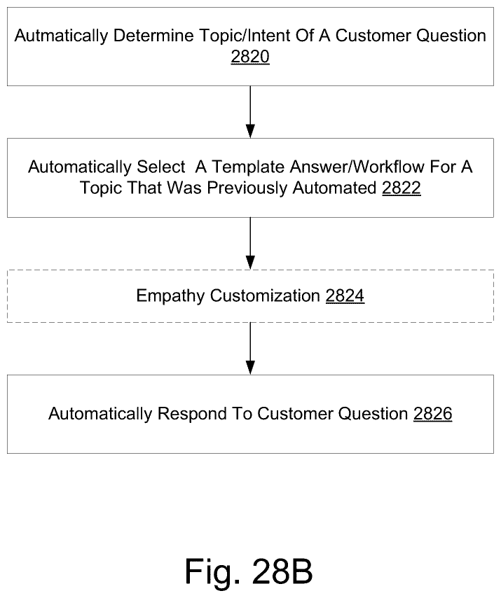

FIG. 28A is a high-level flowchart of an example of a method of automating the generation of template answers and/or workflow for a selection topic. In block 2800, topics are automatically discovered. This may be implemented, for example, using the discover module. In block 2802, a recommendation is made to automate a topic not previously automated. For example, the most frequently encountered un-automated topics may be recommended for automation. In block 2804, the text portions of template answers are automatically generated for selected topics. In block 2806, workflow sequences are generated for template answers for the selected topics. In block 2808, authorization/edits of template answers and workflows are received from a supervisor for the selected topics. For example, a user interface may be provided for a supervisor to review suggested text templates and workflows and authorize or enter revisions. In block 2810, the generation of template answers and workflows is automated for the selected topic.

FIG. 28B is a high-level flowchart of an example of a method of empathy customization. In block 2820, there is the automatic determination of the topic/intent of a customer question. In block 2822, a template answer/workflow is automatically selected for topic that was previously automated. In block 2824, empathy customization is performed for selected template answer/workflow. This may include adding an empathic statement while retaining the substantive aspects of a template answer. In block 2826, the customer question is automatically responded to, including the empathy customization.

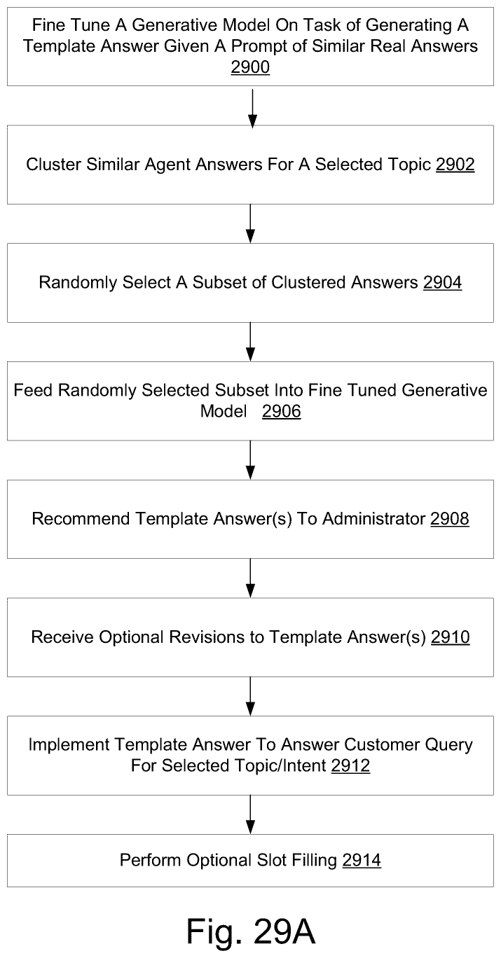

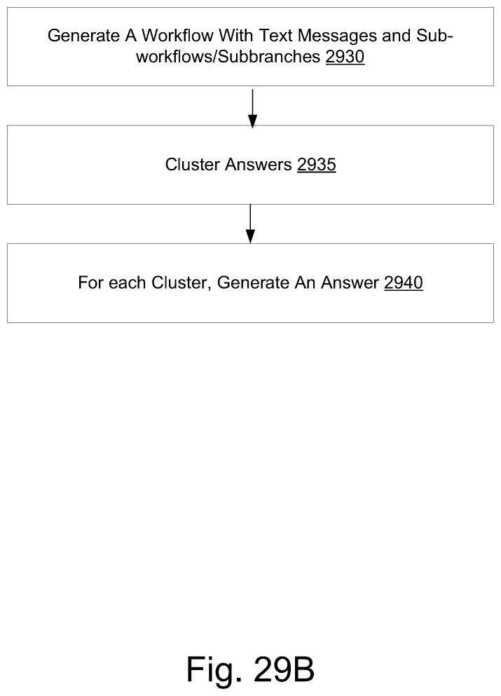

FIG. 29A is a flowchart of an example of using generative AI to generate template answers. In block 2900, a generative AI model is fine-tuned on the task of generating a template answer given a prompt of similar real answers. In block 2902, similar agent answers for a selected topic are clustered. In block 2904, a subset of the clustered answers is randomly selected. In block 2906, the randomly selected subset is fed into the fine-tuned generative AI model. In block 2908, the output of the of fine-tuned generative AI model is used to generate recommended template answer(s) to an administrator/supervisor. In block 2910, optional revisions are received to the template answer(s). For example, an administrator or supervisor may be given options to accept a template answer, reject a template answer, or edit a template answer. The administrator or supervisor may be given a single template answer to approve or edit for a select topic. However, more generally, the administrator or supervisor may be given a selection of template answers to choose from for a given topic. In block 2912, the template answer is implemented to answer customer queries for a selected topic/intent. In block 2914, optional slot filling may be performed.

The method maybe adapted to handle sub-workflows and subbranches of a workflow for a given topic. FIG. 29B is a flowchart of an example of generating an answer with sub-workflows/subbranches. In block 2930 workflows are generated with text messages and sub-workflows/subbranches, In bock 2935 answers are clustered. In block 2940, for each cluster, an answer is generated.

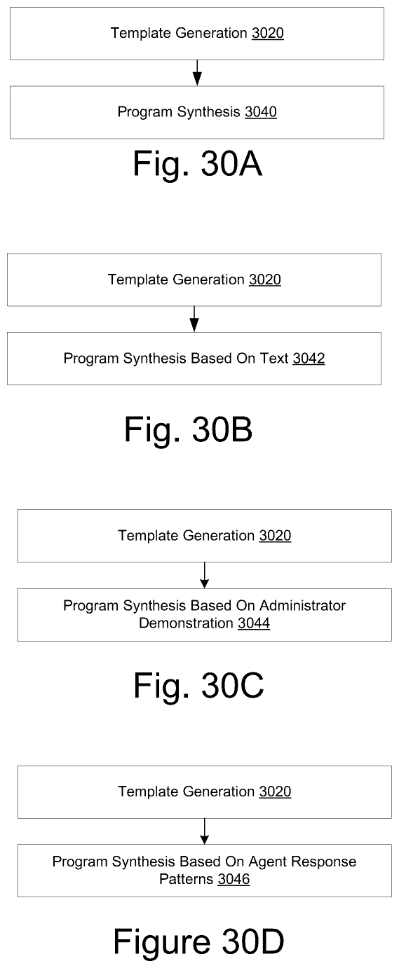

A workflow many be generated for a template based on a variety of different possible types of program synthesis. For example, a complete workflow with text messages, actions, and conditionals may be generated using template generation and program synthesis of workflow steps. FIG. 30A, illustrates a high-level method in which template generation is performed in block 3020 and program synthesis is performed in block 3040. FIG. 30B illustrates an example in which the program synthesis of workflow steps is performed based on the text 2042. For example, the text of a template answer can be used to generate transaction steps that are placeholders (e.g., for API calls). For example, a template answer for processing a refund may have sufficient information to generate transaction step placeholders to check account status, process a refund, and send a confirmatory message. FIG. 30C illustrates an example in which program synthesis of workflow steps is implemented though a proactive intentional demonstration by an administrator of the workflow steps. For example, in block 3044, a browser extension may be used to record a browser session of a demonstration with an administrator. Alternatively, an alternative implementation includes using an iFrame to record a demonstration by an administrator. FIG. 30D illustrates program synthesis based on agent response patterns 3046. A browser extension may be used to detect patterns of how agents resolve similar tickets. For example, tickets agents resolve are resolved into intents. The sessions are recorded (e.g., both clicks and keyboard presses, as well as the actual recording of the call). The network calls are tracked (e.g., API calls) and used to populate values of API steps as action steps in the workflow. For example, heuristics may be identified regarding the most common long subsequence of click, keyboard presses, and API calls to answer a customer question for a particular topic.

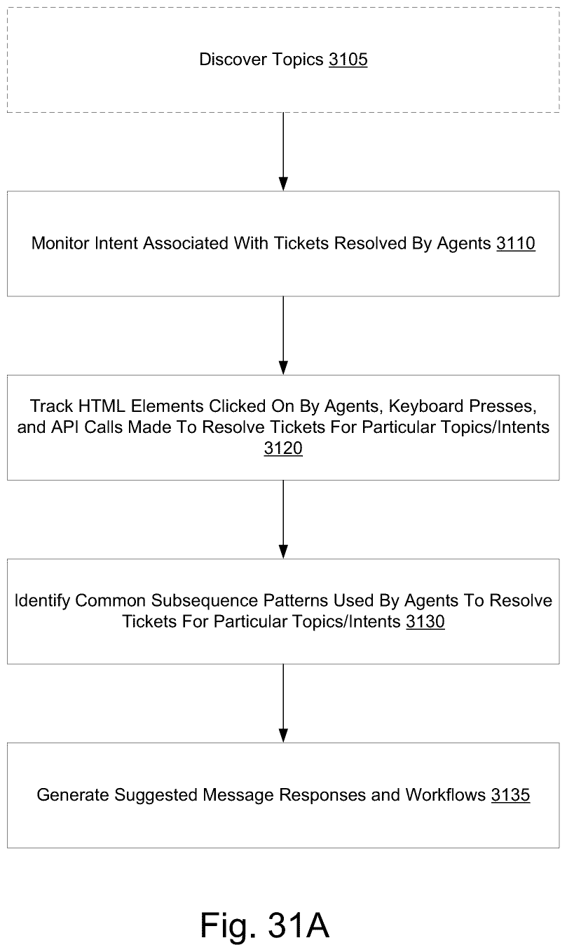

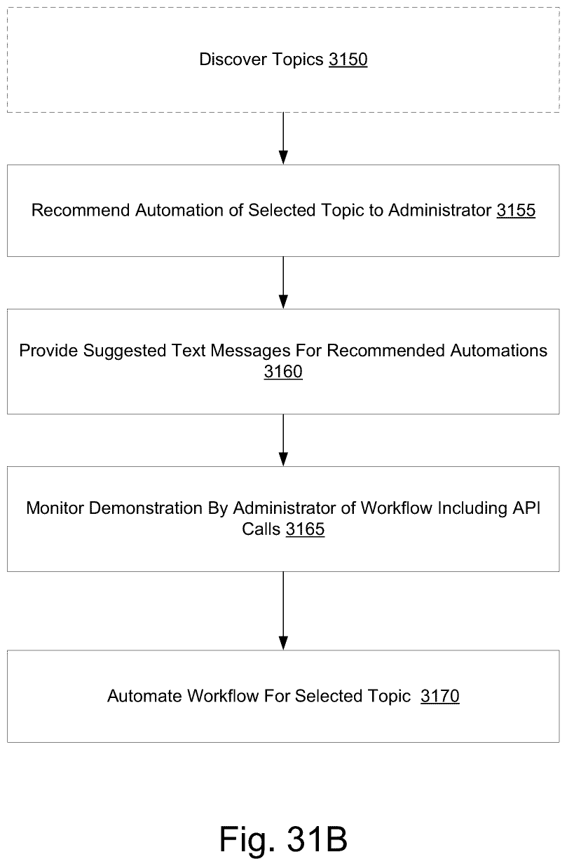

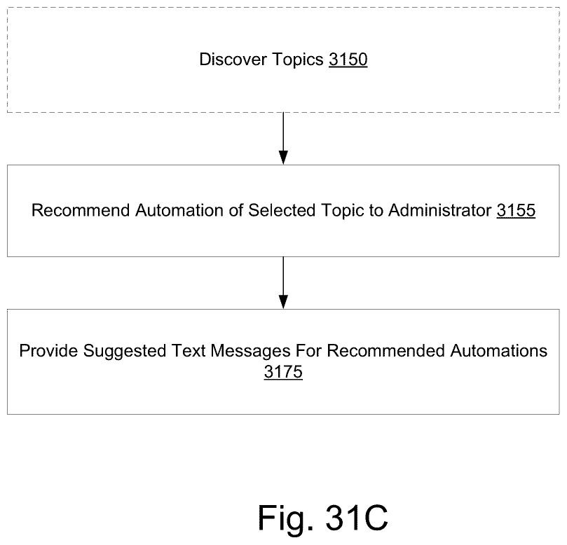

FIG. 31A is a flowchart of a method of an example of performing program synthesis based on monitoring agent responses. In block 3105, the topics of tickets are discovered. In block 3110, the intent is monitored of tickets resolved by agents. For example, tickets related to a topic/intent of a customer request for a refund many be monitored. In block 3120, tracking is performed of HTML elements clicked on by agents, keyboard presses, and API calls made for topics/intents. In block 3130, heuristics are used to identify common subsequence patterns used by agents to resolve tickets for individual topics/intents. In block 3135, suggested message responses and workflow are generated.

FIG. 31B is a flowchart of a method of performing program synthesis by monitoring a demonstration by an administrator. In block 3150, topics are discovered. In block 3155, a recommendation is generated for the automation of a selected topic, which may be provided to an administrator. In block 3160, suggested text messages are provided for recommend automations. In block 3165, a demonstration is monitored of an administrator demonstrating a workflow that includes API calls. In block 3170, the workflow is automated for a selected topic.

FIG. 31C is a flowchart of a method of performing program synthesis in accordance with an example. In block 3150, topics are discovered. In block 3155, automation is recommended of a selected topic to an administrator. In block 3175 suggested messages are provided for recommended automations.

It will be understood the combinations of the different types of program synthesis may be performed in some implementations. For example, some types of topics may have program synthesis performing using one of the previously mentioned techniques whereas other types of topics may have program synthesis performing using previously mentioned techniques.

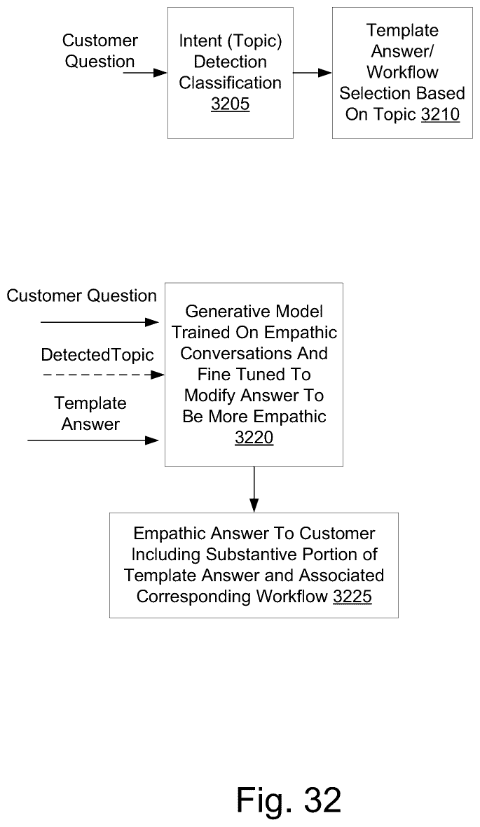

FIG. 32 illustrates functional blocks for customizing template answers to be more empathic. A template answer may deal with a customer's substantive issue but still come across as cold or insensitive. As a few examples, a customer may be seeking to cancel a service for a recently deceased family member. A customer question might for example, say something like, “My wife died. I would like to cancel her account.” Or the customer might include some statement of anger or upset. “I'm really angry. I would like to cancel my account.” A customer might alternatively have a more emotionally neutral question like, “My daughter moved out to go to college, so I would like to cancel her account.” The substance of the response in all three cases may be identical (e.g., “We will cancel the account for you.” But in each of these three cases, a different selection of empathic language could be included. For example, for a customer whose wife died, an empathic response could begin with something like, “I'm sorry to hear that your wife died.”

As illustrated in modules 3205 and 3210, a customer question may be received, intent detection/classification performed in modules 3205, and a template answer/workflow selected based on the topic in module 3210. Empathy customization may include, as inputs, the template answer, the customer question, and the detected topic. These inputs may be provided to a generative model train on empathic conversations and fine tuned to modify an answer to be more empathic in block 3220. Theoretically, other inputs could be provided (e.g., the location of the customer, information on previous interactions with the customer, sentiment/stress metrics based on voice analysis, use of language, or other metrics, etc.). In block 3225 an empathic answer is provided to the customer that includes the substantive portion of the template answer and that has associated with the corresponding workflow.

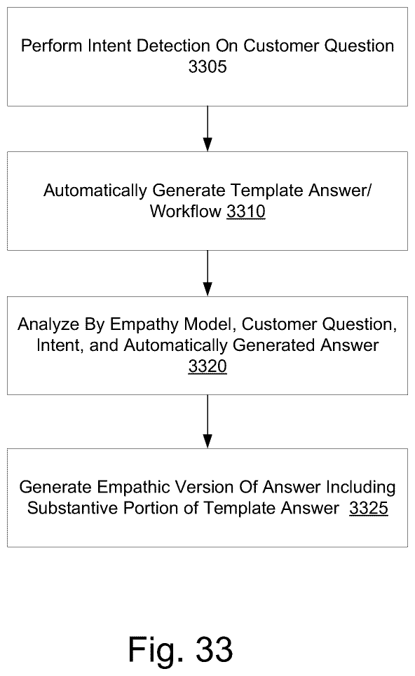

FIG. 33 is a flowchart in accordance with an example. In block 3305, intent detection is performed on a customer question. In block 3310, a template answer/workflow is automatically generated based on the detected intent. In block 3320, the customer question, intent, and the automatically generated template answer is analyzed by the empathy model. In block 3325, an empathic version of the template answer is generated that includes the substantive portion of the template answer.

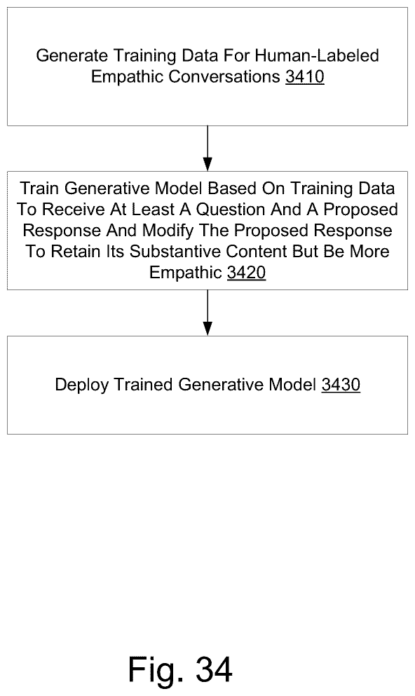

FIG. 34 is a flowchart of a method of training an empathic model in accordance with an example. In block 3410, training data is generated from human-labeled empathic conversations. As an example, training data may be generated based on examples of how empathic human agents modify template answers. In block 3420 a generative AI model is trained, based on the training data, to receive at least a question and a proposed response, and retain the substantive content but make it more empathic. In block 3430, the trained generative model is deployed.

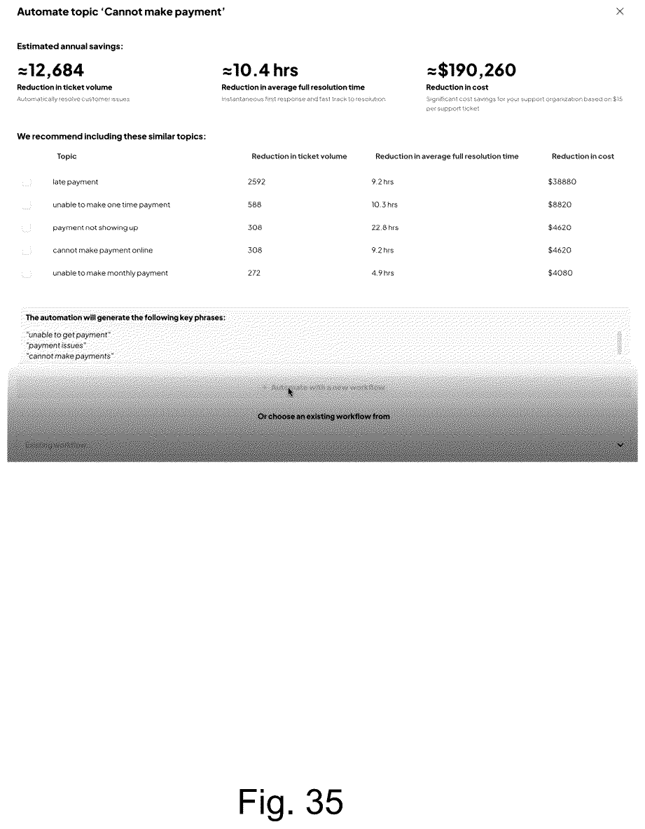

FIG. 35 is an example of a user interface to recommend automating a topic. In this particular example, the UI is suggesting automation of the topic, “Cannot make payment.” This may include showing estimated savings in terms of agent time and agent cost.

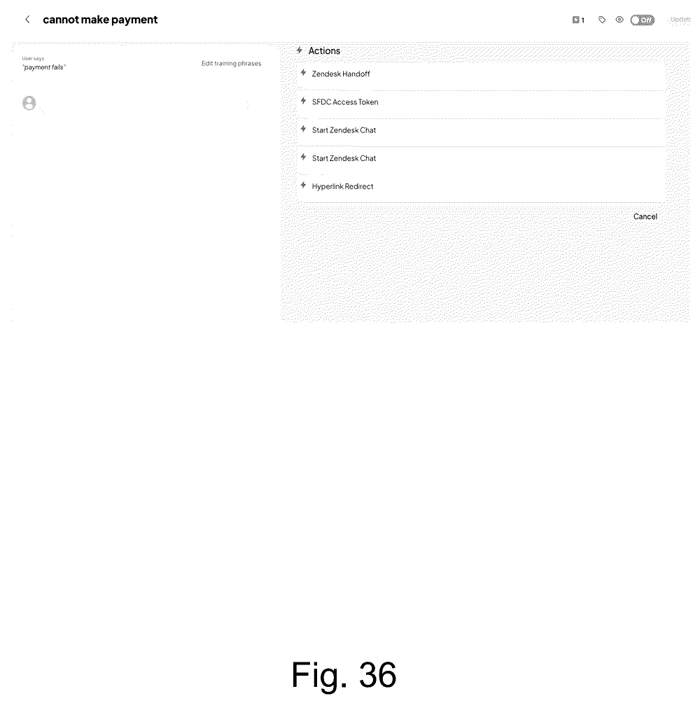

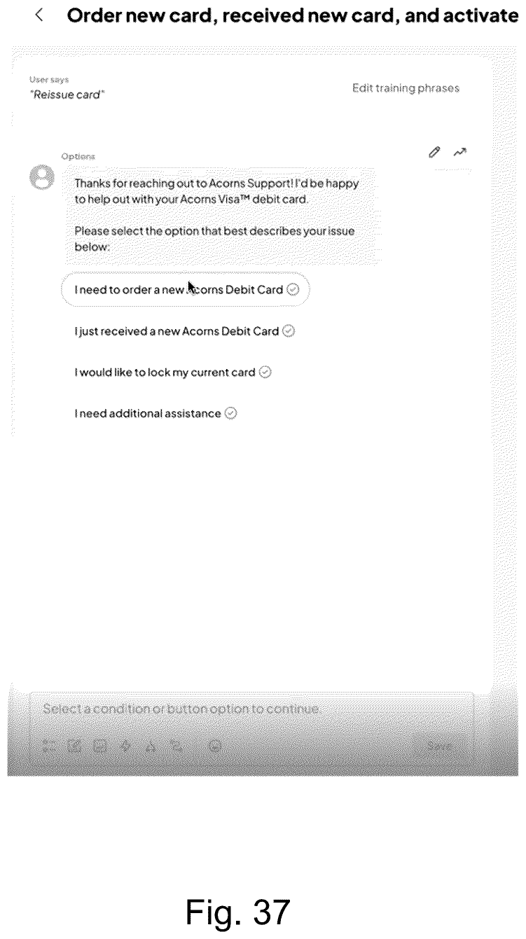

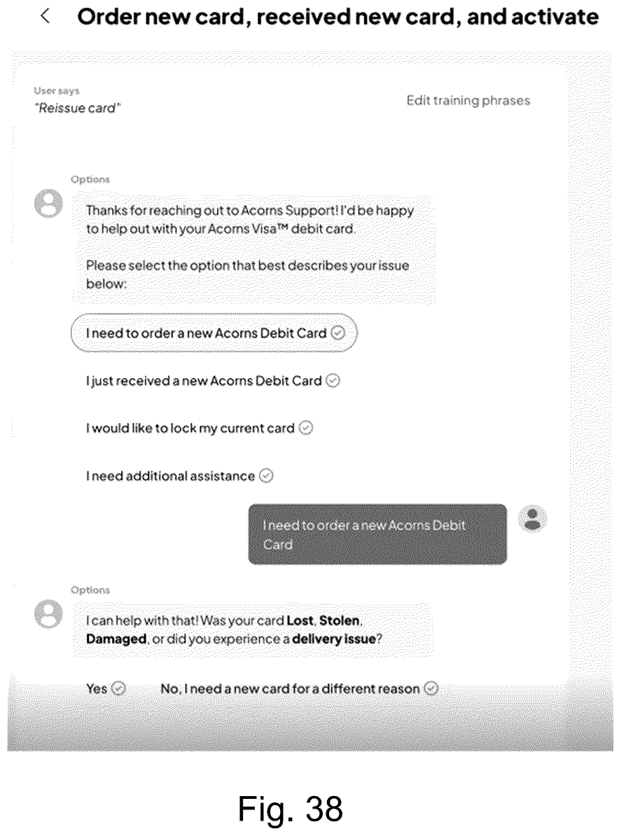

FIG. 36 illustrates a UI displaying suggested actions for the topic “cannot make payment.” Example actions in this example include ZendeskHandoff, Start ZendeskChat, hyperlinkRedirect, and SFDCaccessToken. That is, an administrator can be provided with options to create workflow steps for a particular topic. As illustrated in the user interface of FIG. 37, a workflow can be branched. For example, a topic for “reissue card” may branch depending on options the user selects from. FIG. 38 illustrates the user selecting an option from the choices in FIG. 37, which leads to a branching to a response for the selected option.

### Intent Detection Workflow for Email

In one implementation, the solve module 215 is designed to support handling long-form email tickets by detecting intent implementing a complete workflow to resolve a customer's query/concern. The workflow, may for example, implement steps to determine a customer's intent and implement a workflow to provide information a customer requires, but may also implement API calls to access information or resolve issues for the customer.

Resolving a customer's email query automatically, without deflecting it to a helpdesk, improves overall system performance. Some customer emails are simple information requests that can be addressed once the intent of the customer's email is determined and their intent is verified. However, customers sometimes have issues in their query that require implementing a workflow to resolve their concerns, such as issuing a refund, cancelling an order, changing a reservation time, etc.

As one example, an individual customer email may be input by a customer to a webform (or is converted into a webform format) that provides space for the customer to input a longform query. This is unlike chat, which is typically single lines of text and which is input by the user in response to a prompt. An individual email from a customer may include several lines of text, even the equivalent of a long paragraph or paragraphs. For example, a customer requesting a refund could, in some cases, write several sentences into an email webform, even the equivalent of a long-form paragraph or paragraphs.

There are several potential challenges that arise in automatically generating a workflow to address the customer's concern in an email in a quick, efficient, and user-friendly manner. One issue is that the customer's initial email may be long and also ramble. This can make it hard to accurately determine the customer's intent directly from their email.

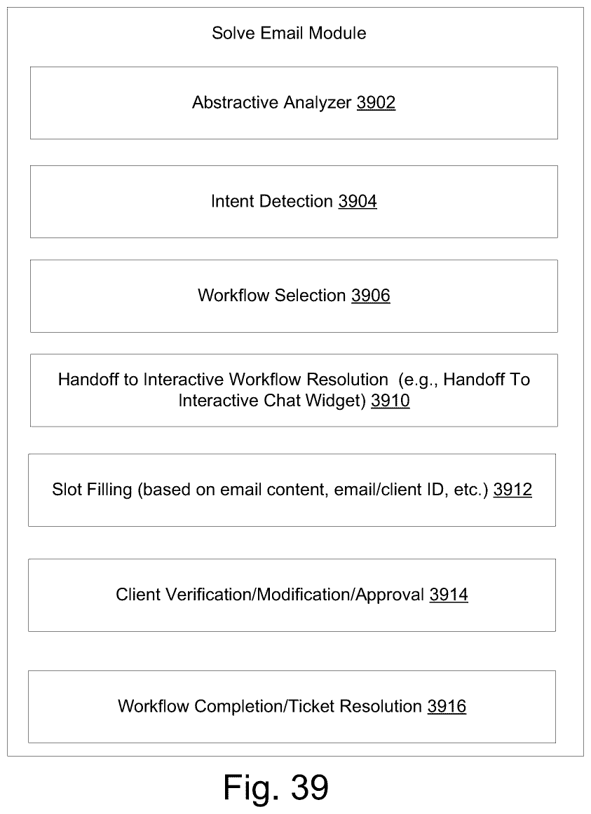

FIG. 39 illustrates an example of some aspects of a solve module for responding to a customer's email query and generating a workflow to resolve the issues of their query. A customer's email may, for example, be part of a ticket received by a helpdesk. An attempt is made by the solve module to resolve the customer's issues associated with the ticket and automatically respond back to the customer.

In one implementation, an abstractive summarizer 3902 analyzes the email of the support ticket and generates an abstract-summary. As previously discussed regarding FIGS. 16, 17, and 18, the unstructured email data of a ticket may be converted to structured (or at least semi-structured) data to generate a short description or summary of the email. For example, a long rambling email may include several sentences about various issues and problems a customer faced in running payroll. This might for example, be summarized into an abstract such as “Customer unable to run payroll.” In block 3904, intent detection is performed based on the summary. For example, the intent detection may include identifying which topics in the topic taxonomy the abstract most closely corresponds to. For example, “unable to run payroll” might in some cases map to a discovered topic corresponding to “payroll problem.” As previously discussed, the overall system may generate a granular taxonomy of discovered topics. In one implementation, the solve module has access to a classifier trained to identify a granular taxonomy of issues customers are concerned about. The granular taxonomy of topics may correspond, for example, to that previously described technique for the discovery of a granular taxonomy of topics based on an analysis of tickets in FIGS. 16, 17, and 18, That is, the solve module may leverage off of the granular taxonomy of topics. However, in theory the solve module could employ a variation of the previously described techniques to generate a granular taxonomy of topics.

In block 3906, a workflow response is identified and triggered based on intent. As previously discussed, a variety of tools may be included to aid administrators to build workflows to resolve customer tickets. This may include, for example, generating recommendations to automate resolving certain types of customer tickets and tools to aid in designing workflows. For example, if the customer's intent was to obtain a refund, then a refund workflow response may be selected. As another example, if the workflow response deals with changing travel tickets, the workflow response for changing travel tickets may be initiated.

In block 3910, there is a handoff to an interactive widget (e.g., a chat widget) for workflow resolution. In some implementations, the customer is given an option in the user interface to have an AI virtual assistant resolve the issues associated with their ticket, such as by pressing a button.

The AI chat widget may optionally perform steps such as confirming the intent of the customer, asking follow on questions, etc.

In block 3912, slot filling is performed. In a workflow there may be various variable fields of information that need to be filled out for a workflow. These can be described as slots in terms of slots of information for a user to verify or fill out. For example, there may be various slot fields to complete in a workflow before an API call can be generated, such as an API call for issuing a refund, changing airplane flights, etc. To assist the user, in one implementation as many of these slots are automatically filled as possible. For example, in one implementation, information in the text of the customer's email may be accessed. In some implementations, additional customer information may be accessed based, for example, on the customer's email address. For example, the full name and address of the customer may be discernible in some cases based on their email address. In some cases, other information about the customer, such as a credit card number and information on previous orders, may be accessed directly or indirectly using the email address as an index into other databases.

Slot filling may be performed in various ways. In one implementation a data set is built for zero-shot relation extraction. As an example, given a slot name and some context (e.g., for purchasing/changing tickets a ticket subject and description), a zero-shot extraction technique may extract an appropriate fill for that slot name.

In one example, a data set for slot filling may, for example, be based on examples of a large number of encyclopedia-type data sets. As another example, in one implementation a custom annotation model and an annotated data set is used to train a model to perform slot filling.

In some implementations, generative large language learning models are used to perform slot filling. The generative large language learning model may be trained to perform slot filling. However, as generative large language learning models are expected to increase their capabilities, it can be expected that in the future minimal training with a few example prompts might be sufficient for a generative large language learning model to perform slot filling.

In block 3914, client verification/modification/approval is performed. For example, slot filling may in some cases fill many but not all slots. So, for example, in some implementations, the remaining slots a customer needs to fill could be shown. Also, while slot filling using an AI model can be highly accurate, the user may be provided with an opportunity to modify the contents of the slots, should the user identify that any slots have errors. For examples, suppose a customer sends a long and rambling email about changing their flight. The abstractive summarizer may summarize that to “Need to Change Airline Tickets”, the topic may be identified, and a workflow triggered for changing airline tickets with airlines. The handoff to the AI chat widget may ask the customer to confirm the customer wants to change their tickets. Slot filling may be performed filling in as many slots as possible, within a pre-selected confidence factor, based on the information in the original email. However, there may still be one or more slots that a customer needs to fill in. There also may be an error in how the AI filled out an individual slot for a variety of reasons. For example, for the case of travel, there are potential ambiguities in a destination. For example, if a customer says they want to change their ticket and fly to Moscow, there is more than one Moscow (e.g., Moscow, Russia vs. Moscow, Idaho). As another example, there's potential ambiguity between a customer's previous address and a current address, etc. In one implementation, the customer can fill in any missing slots, correct any slot errors, and approve the slot information. The slot information, in turn, may correspond to the information required to implement a workflow, including any API calls, such as in the example of changing an airline ticket contacting an airline reservation system and changing a ticket.

In block 3916, the workflow is completed/the ticket resolved. This may include initiating the API calls needed to resolve the ticket, confirming the API calls were acknowledged, and reporting to the customer that the necessary actions for the workflow has been taken (e.g., the ticket was changed, your refund has been issued, etc.).

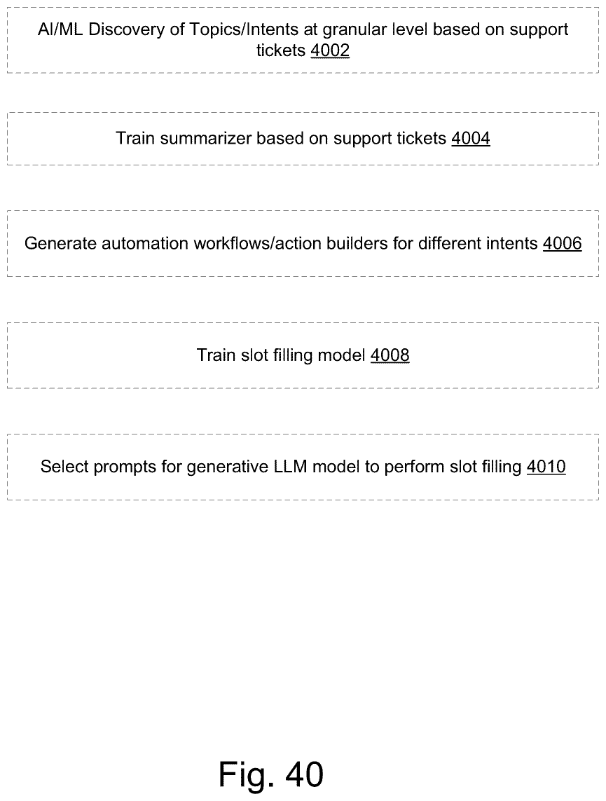

FIG. 40 illustrates some of the training and other preparation to be performed initially or periodically in order to provide the capability to automatically identify intent of emails and generate workflows to resolve tickets. In block 4002, AI/ML discovery of topics at a granular level based on support tickets is performed. As previously discussed, this may leverage off of the previously discussing techniques for topic discovery and use the same topics discovered for the rest of the system. Alternatively, a variation of the previously discussed topic discovery techniques may be used to, for example, customize the discovery of topics for emails, in the unlikely event that there is a statistical difference in the topics raised for long form email tickets versus other types of tickets. In block 4004, the abstractive summarizer is trained based on support tickets. In block 4006, automation workflows are built for different intents where a workflow may have a branch specifying specific actions to resolve a ticket. In block 4008 a model may be specifically trained for slot filling. Alternatively, as illustrated in block 4010, prompts may be selected for a generative LLM model to perform slot filling. For example, slot filling may include issuing calls for a generative LLM model and any prompts necessary for the generative model to perform slot filling for a particular workflow.

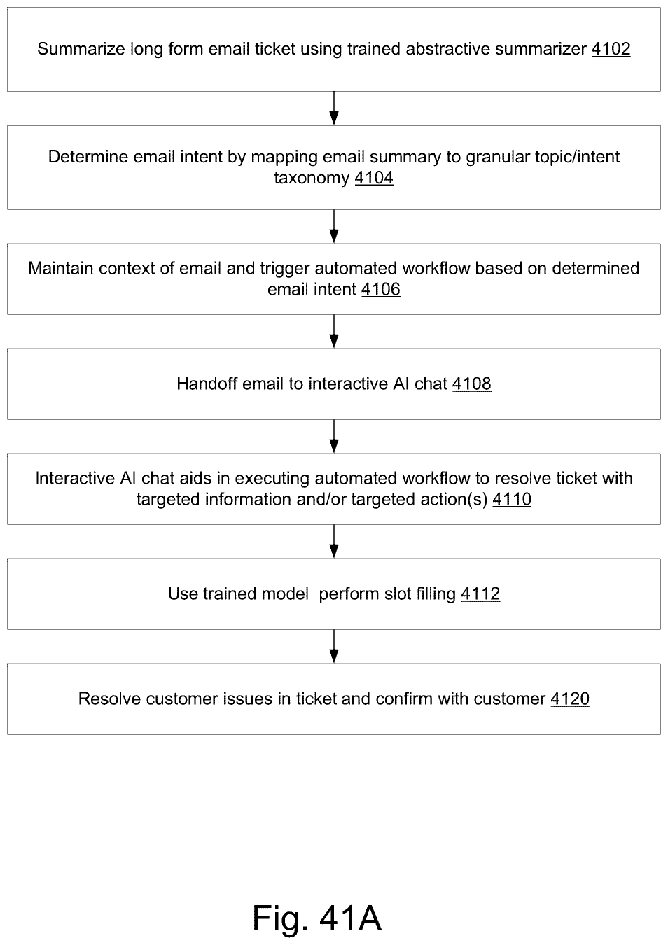

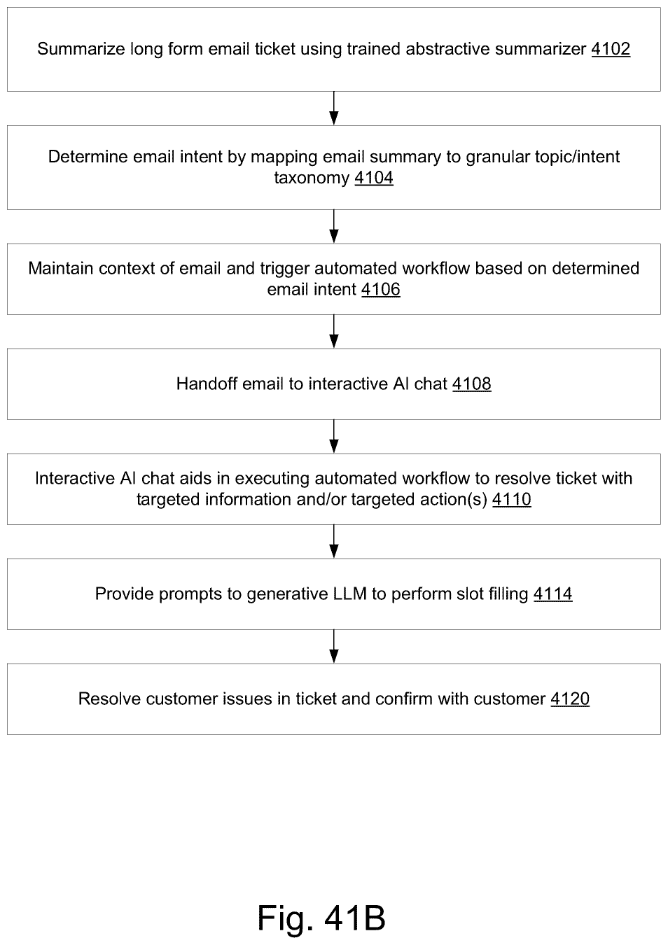

FIG. 41A is a flow chart of a method of performing intent based resolution of customer emails and FIG. 41B is a variation of the method of FIG. 41A.

In block 4102, a long form email ticket is summarized using a trained abstractive summarizer. In block 4104, the intent of an email is determined by mapping the email to summary to a granular topic/intent taxonomy and, for example, determining the closest match. In block 4106, the context of the email is maintained and an automated workflow is triggered based on the determined email intent. In block 4108, there is a handoff of the email to interactive AI chat. For example, a webform UI may include a button or other feature for the customer to select interactive AI chat mode to resolve their ticket, which may depend on the particular case included providing the customer with information or taking an action step, such as issuing a refund, depending on the particular workflow that is triggered. In block 4410, the interactive AI chat aids in executing the automated workflow to resolve the ticket, such as supplying information a customer needs and/or taking specific actions, such as issuing a refund. Slot filling is performed in block 4112, which may, for example, be performed using a trained model. Users may in some implementations verify that the information filled into slots is accurate and/or fill in any slots that were not filled in slot filling. The method may include other steps to resolve the issues in the ticket, such as issuing API calls, notifying the client various actions have been completed (e.g., a refund has been issued to and you will receive an email verifying the refund) and confirming with the client that all of their issues have been resolved in block 4120.

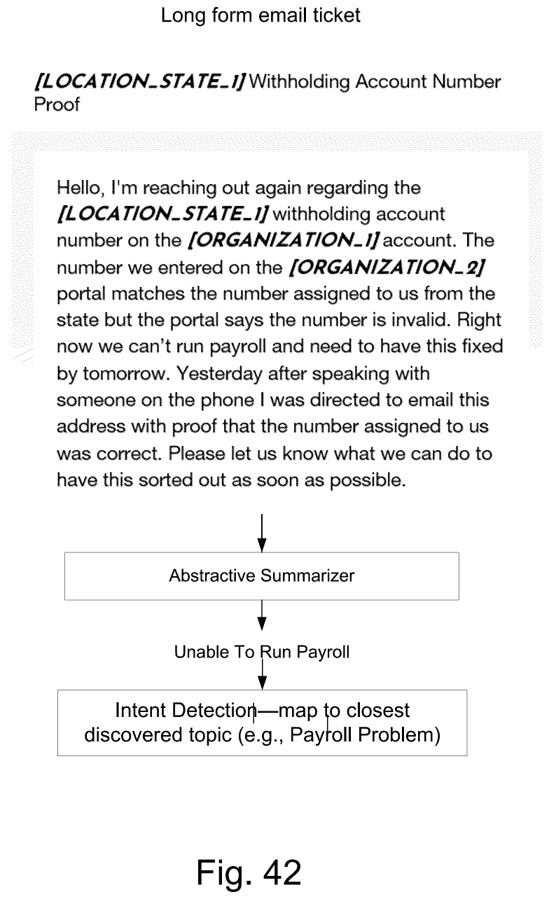

FIG. 42 illustrates an example of a rambling long-form email ticket. It would be hard to directly determine customer intent from such a rambling long form email ticket. However, by processing the text in an abstractive summarizer, the summary is “unable to run payroll.” The summary “unable to run payroll” may be mapped to the closest topic in a granular taxonomy, such as a topic for “payroll problem.”

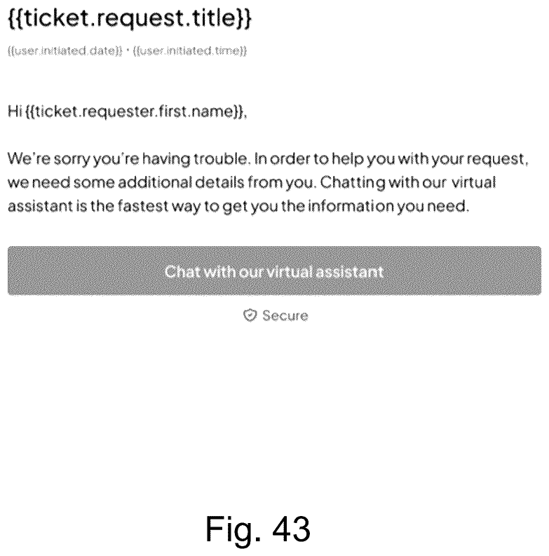

FIG. 43 illustrates an example of a user interface inviting a customer to chat with a virtual AI assistant to resolve the ticket.

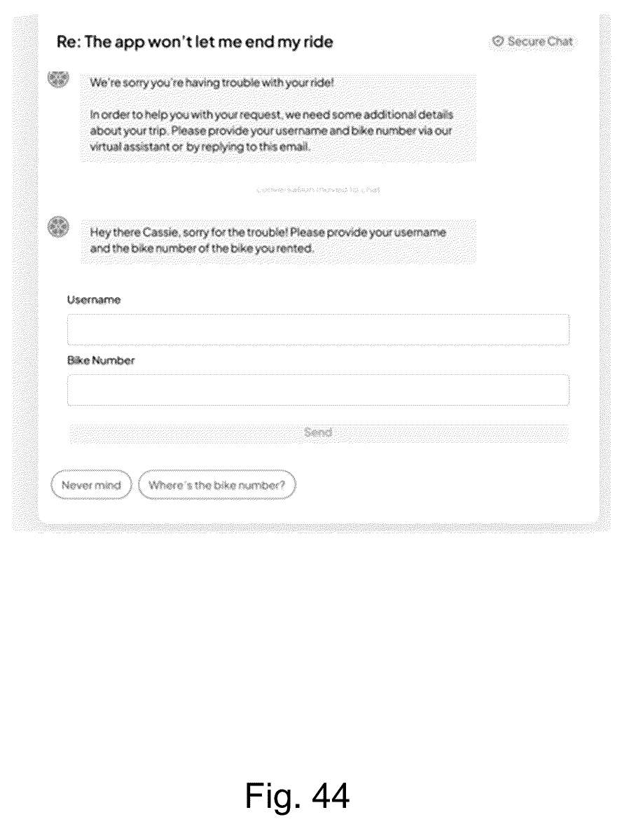

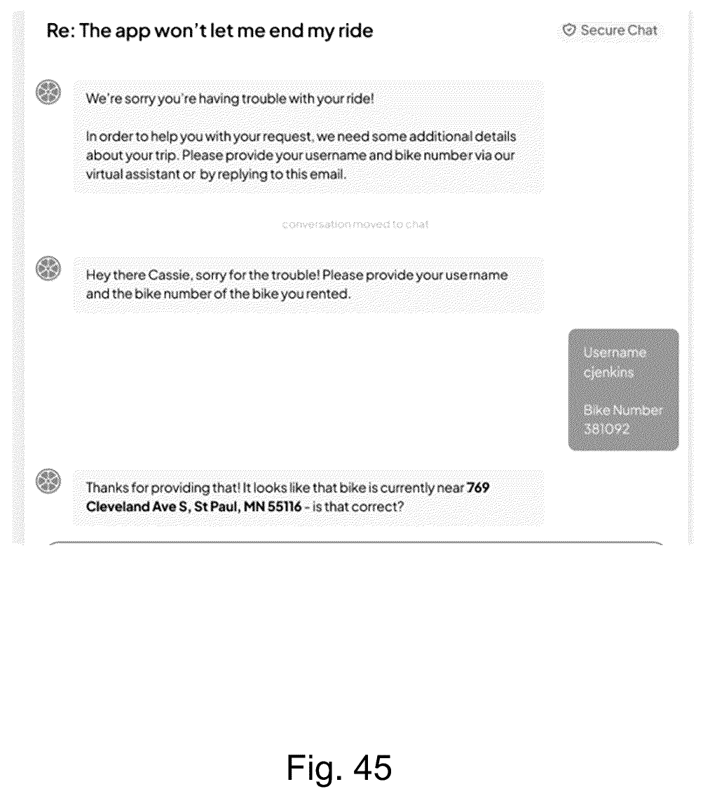

FIG. 44 illustrates an example of an AI chat widget, requesting additional information in slot fields to resolve a ticket for ending a bike ride on a bike share rental system. In FIG. 45, the AI chat widget identifies the location of the bike using an API and confirms the location with the client. Other steps in a full workflow in this example may include confirming, with an API, that the bike has been returned and notifying the customer.

Autonomous Agent with Natural Language Workflow Policies

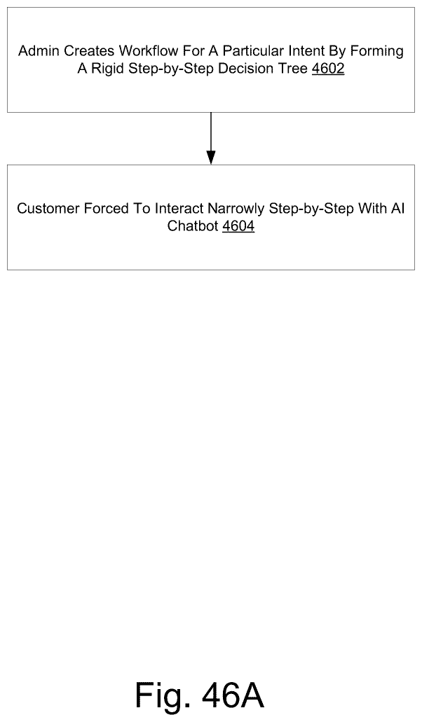

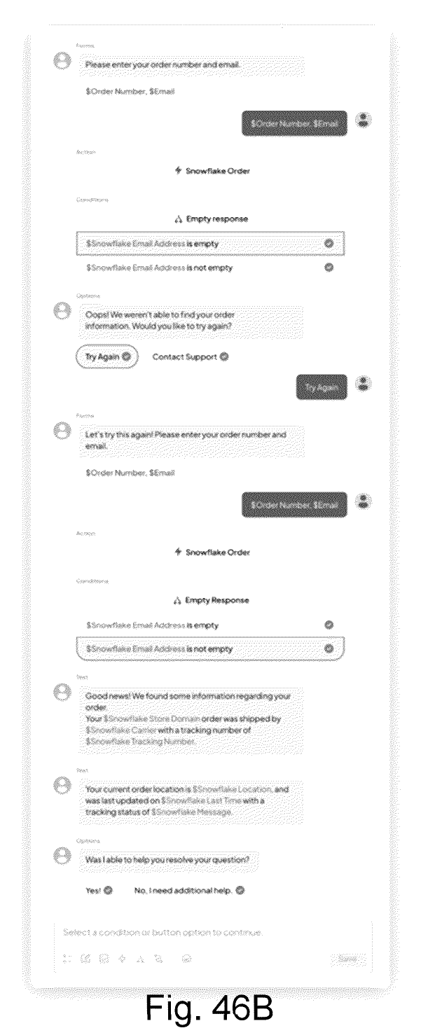

Referring to FIG. 46A, as previously discussed, in some implementations an administrator may build a workflow for a detected intent, where as previously discussed the detected intention may correspond to granular topic corresponding to a specific customer issue. This may be done using, for example, having an administrator select an intent to build a workflow. As previously discussed, in some implementations, a recommendation may be given to an administrator to consider automating a workflow for a particular intent (e.g., “cancel my order”). When the intent is detected in a customer ticket, the workflow for that intent is triggered by the Solve module.

In this implementation, as illustrated in block 4602, the administrator to design a decision tree of responses, actions, and API calls to complete a workflow. For example, a workflow for cancelling an order or issuing a refund may be designed by an administrator as a decision tree in which the workflow goes through a rigid step-by-step decision tree of simple questions, receiving answers from the customer, and actions, such as requesting a customer to input information (e.g., product order number), confirm details, and go through a decision tree that determines when an action is performed (e.g., cancel an order). While this approach of building a workflow works, it has the disadvantage of being complex and unnatural for system administrators to build. It's also very rigid. That is, a system administrator may find it cumbersome and time consuming to create a decision tree for a complex workflow. Also, another problem illustrated in block 4604 that such a rigid decision tree assumes the customer will respond with a precise step-by-step manner with an AI chatbot. However, customers may not always respond precisely to questions. For example, a customer may ramble in their response, which complicates designing a decision tree that will solve a customer's issue.

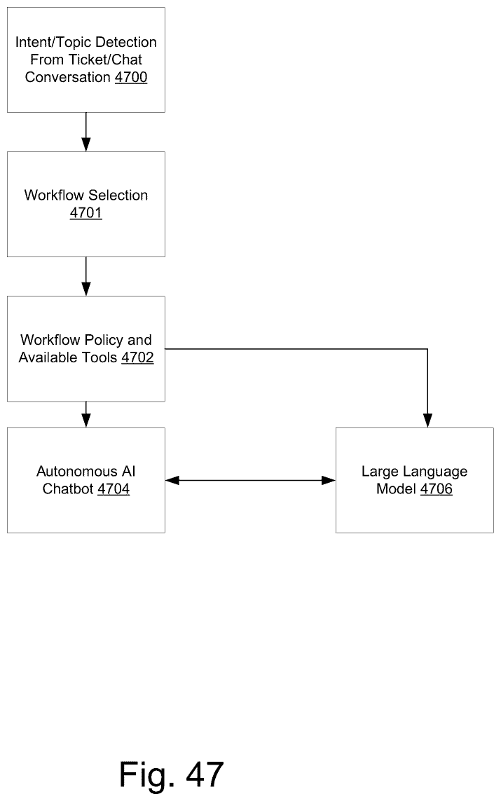

FIG. 47 illustrates an autonomous AI chatbot 4704 that interacts with a large language model 4706 to implement a workflow. The autonomous AI chatbot 4704 may, for example, include a machine learning model to perform selected tasks of an AI chatbot. Access to the large language model 4706 may be performed to use the capabilities of a large language model to enhance the capabilities of the AI chatbot 4704 to act as an autonomous agent to solve customer tickets.

It will be understood that as an implementation detail the AI chatbot may interact with a large language model, although in some implementations, the large language model may perform substantially all of the functions of the AI chatbot. In other words, in some implementations the large language model serves as the autonomous AI chatbot agent, but more generally an Autonomous AI chatbot agent may use a large language model to enhance its capabilities. This is just a routine division functionality performed between different software modules of the Solve module and other components of the system . . . .

An intent/topic is detected from the customer ticket, including an analysis of customer texts in block 4700. The intent detection may, for example, be based on the previously described examples of intent detection. Workflow selection is performed in block 4701. In block 4702, a workflow policy and available tools are selected. Thus, for example, if a customer's ticket/text message indicated that their intent is to cancel an order, the workflow for “cancel order” is triggered, a workflow policy and available tools for “cancel order” is accessed, and autonomous AI chatbot 4704 and large language model 4706 interact to implement the cancel order workflow.

It should be noted that a tool/action has associated with it a definition of what the tool is, its inputs, and what types of outputs in may have. For example an API tool to check an order status may require as an input an order number and either fail (no information available) or result in order status information.

In one implementation, the large language model is provided to support an AI chatbot implementing a workflow. For example, in one implementation, a customer may input free-form text describing their problem. Upon intent detection (e.g., detecting that the intent of the customer corresponds to checking order status), a workflow is triggered. When the workflow is triggered, the AI chatbot has available to it the workflow policy, details on available tools for that workflow (e.g., options for function calls, such as API calls, calls to execute simple pieces of code to implement function calls such as a handoff to an agent, and any general default function calls, etc.) and may also have general information regarding inputs/outputs for an action. In some implementations, an administrator may also provide pre-configured specific text messages to be used in certain instances for a workflow. In other cases, the administrator may provide a general description of how to respond.

In one implementation, for a given AI chatbot conversation associated with a particular workflow, the large language model has available to it as prompts the conversation associated with a ticket, the workflow policy description, a list of available tools, descriptions of tools (e.g., descriptions of inputs/outputs for an API call), general default information on actions the AI bot can take, and may optionally include specific text to be used for particular instances. The large language model may also, in some cases, be provided with the intent for the workflow.

As an example, the large language model may be used by the autonomous AI chatbot 1) determine what the next step it should take and what actions it should perform in an interactive conversation with a customer; 2) determine what inputs it needs from a customer or from other sources to execute tools; and 3) determine what text responses it should give to the customer.

Additionally, in some implementations, the large language model is provided with prompts that serve as “guard rails” to help ensure proper operation of the large language model. For example, a guard rail could include guard rail prompts to remind the large language model know it is an AI customer service chatbot, it must respond truthfully to customer questions, it must follow the workflow policy provided, etc.

There are several advantages to this approach. The first is that an administrator can create a freeform natural language description of a workflow policy that's similar to how they would instruct a human being. In contrast, it's harder for administrators to create a complex rigid decision tree to handle a complex workflow. The customer also has the possibility to have a more natural and human-like conversation with an AI chatbot.

The large language model may be implemented using generative AI models such as ChatGPT or GPT4. Additionally, the large language model may be a large language model customized for customer support. In some instances, the large language model may be trained on a set of customer support examples.

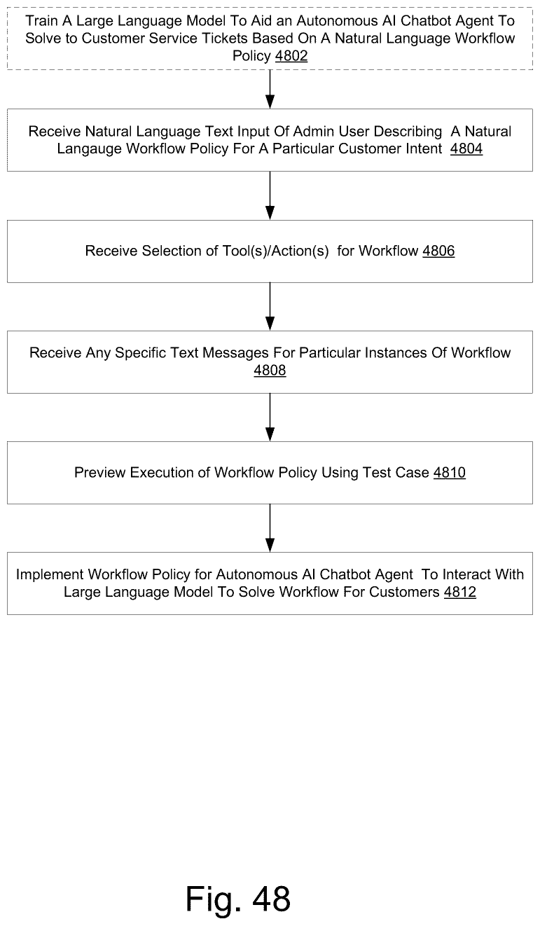

FIG. 48 is a flowchart of an example method of generating a natural language workflow policy to aid in solving a customer support ticket. The workflow policy may include, for example, a description of conditions, responses, and actions. The actions may include the use of one or more tools (e.g., API calls or other function calls), where in some implementations a menu of available tools is provided. There may also be one or more default tools available.

In this example, in block 4802 there may be optional training of a large language model to aid an autonomous AI chatbot agent to solve customer service tickets based on a natural language workflow policy. In block 4804, a natural language text input of an admin user is received describing a workflow policy for a particular customer intent. In block 4806, a selection of tools/actions for a workflow is selected for a workflow. For example, a user interface may be provided a list of available tools/actions, such as API calls, handoff to a human agent, etc. In block 4808, an admin may provide specific text message for particular instances of a workflow. In block 4810, an admin may be provided a preview of the execution of the workflow policy for one or more test cases. For example, an admin may tweak the text of the workflow in response to a preview. In block 4812, the workflow policy is implemented.

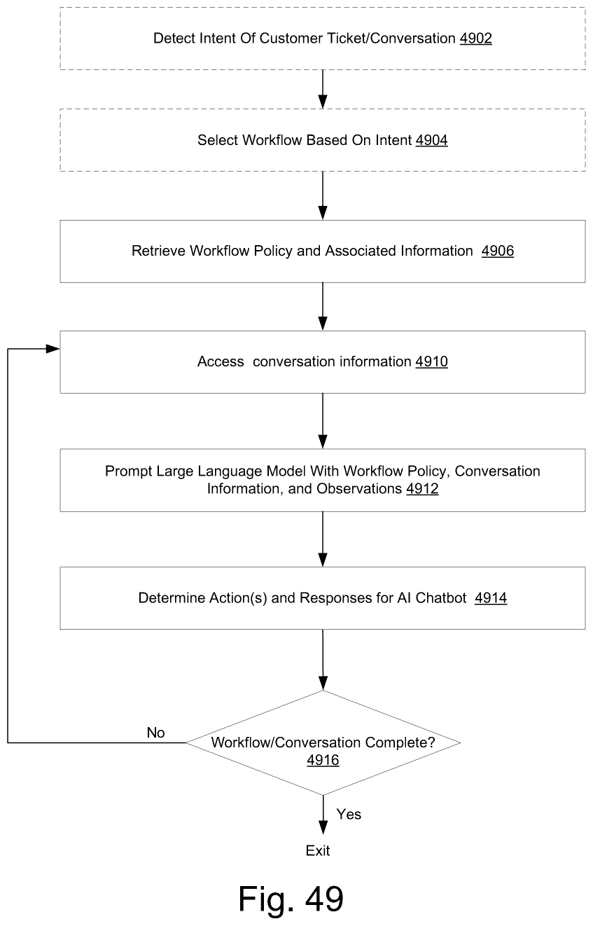

FIG. 49 is a flowchart of an example of using a workflow policy in accordance with an implementation. In block 4902, the intent of a customer ticket/customer is detected. This may, for example, be performed using any of the previously described intent detection techniques in this application, such as using the granular topic detection/taxonomy discussed earlier. In block 4904, a previously created workflow is selected based on intent. In block 4906, the workflow policy and associated information is retrieved/accessed for the selected workflow. In block 4910, the conversation information is accessed. In block 4912, the large language model is prompted, where the prompts may include information on the conversation, the workflow policy, and observations regarding the results of previous actions/use of tools. In block 4914, a determination is made of actions and response for the autonomous AI chatbot. In block 4916, a decision is made whether the workflow/conversation is complete. The process may loop and be performed continuously to attempt to solve a customer ticket.

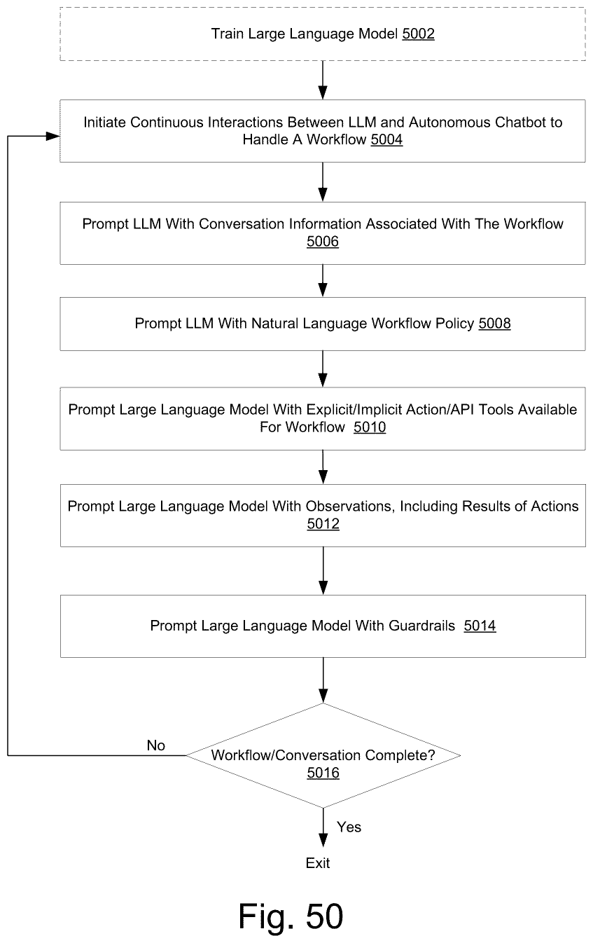

FIG. 50 is a flowchart from the perspective of the large language model.in block 5002, the large language model is optionally trained to use a natural language policy to aid in solving customer tickets. In block 5004 continuous interactions between the large language model an autonomous AI chatbot is initiated to handle a workflow. As previously discussed, there may be different divisions in functionality between the autonomous AI chatbot and the large language model, depending on implementation details. In block 5006, the large language model is prompted with conversation information related to the workflow. This may include, for example, the entire conversation, the conversation after the intent was detected, or relevant portions of the conversation. In block 5008, the large language model is prompted with the workflow policy. In block 5010, the large language model is prompted with explicit/implicit tools and actions available for the workflow. This may include the tools/action specified in the workflow and default tools/action that can by implicitly used, such as asking customers for missing information. In block 5014, the large language model is prompted with guardrail prompts. In block 5016 a determination is made whether the workflow/conversation is complete. If not, the process loops to support continuous interactions.

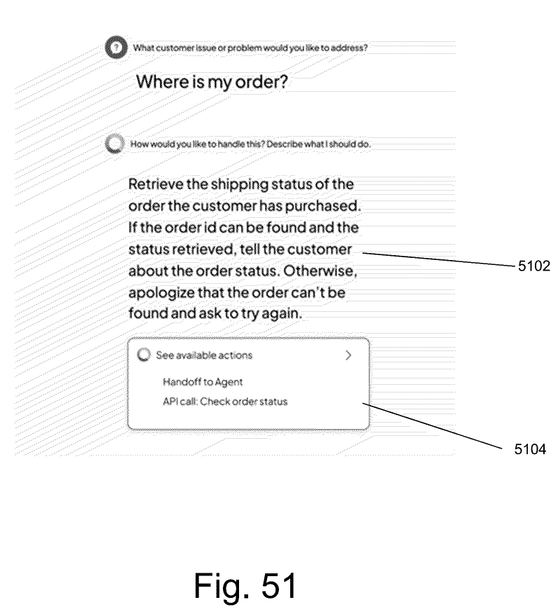

Referring to the example user interface of FIG. 51, in one implementation, an administrator inputs a natural language description of a workflow policy into a text box 5102. An administrator may also select actions. As examples of actions, FIG. 51 shows a handoff to agent action and an API call (e.g., check order status) in block 5104, although more general a UI may provide a list of all available actions from which to select from. There may also be implicit default actions that are supported. In the example of FIG. 51, an administrator inputs a freeform natural language text description of a policy to check the order status for a customer. In this example, an admin has defined in a few sentences general instructions they might tell to a human user. “Retrieve the shipping status of the order the customer has purchased. If the order id can be found and the status retrieved, tell the customer about the order status. Otherwise, apologize that the order can't be found and ask to try again.” Note that this is a natural language instruction in which it is assumed that a large language model can work out the details based on the natural language text instructions and the list of available actions, which in this example includes an API call to check the order status.

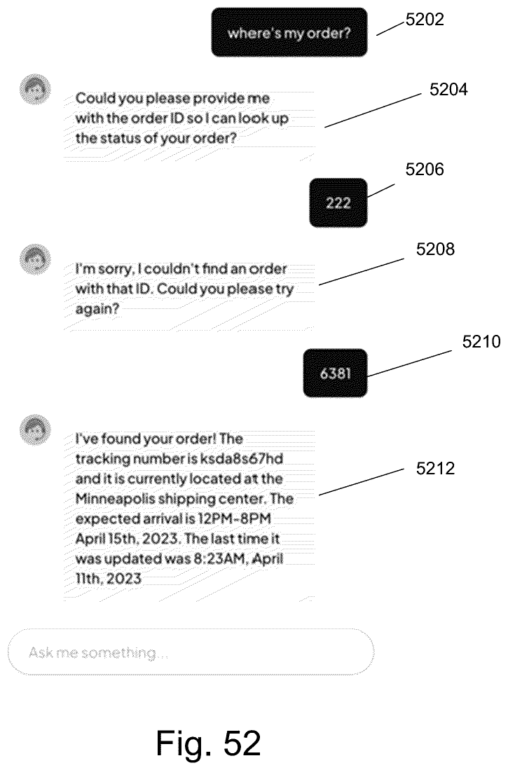

FIG. 52 illustrates a sequence of conversations interactions between an AI chatbot and a customer in which the AI chatbot implements a workflow policy similar to that of FIG. 52. In block 5202, a customer asks where is their order. In block 5204, the AI chatbot asks the customer for their order ID so the AI chatbot can look up the status of the customer's order. In block 5206, the customer accidently enters an incorrect order ID (e.g., “222”). In block 5208, the AI chatbot apologizes it couldn't find an order with that ID, and invites the customer to try again. In block 5210, the customer inputs a correct order ID (e.g., “6381” in block 5210). In block 5212, the AI chatbot answers that if found the order and provide details about the order status.

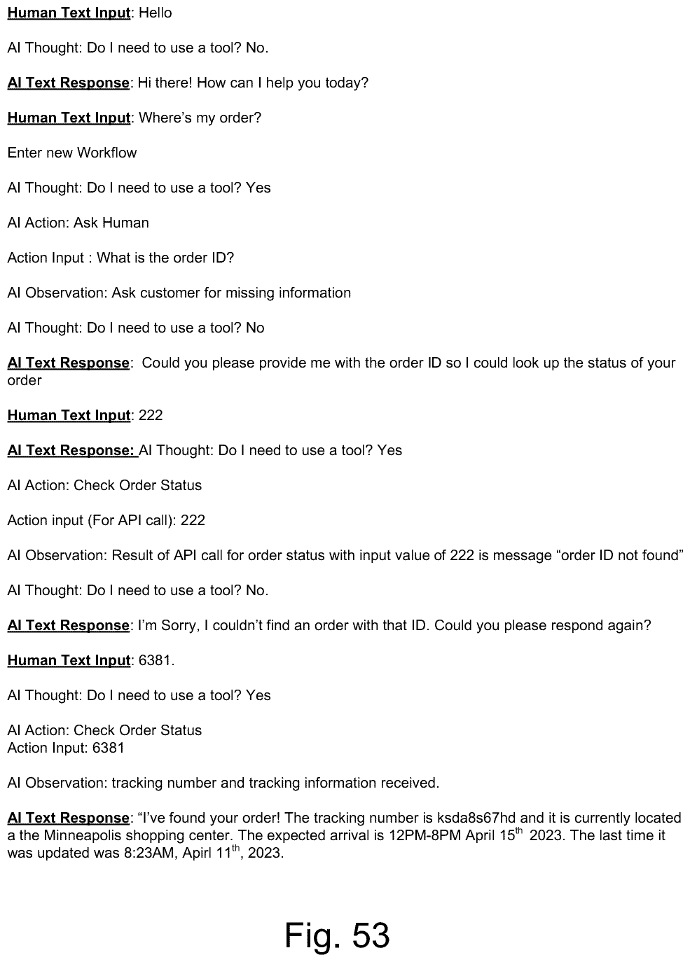

In one implementation, the AI chatbot will be able to carry out conversations with customers while having internal thoughts about what to say to the customer, given the workflow policy description and the available tools/actions. An example of Al's thoughts in FIG. 53 are shown to illustrate how the AI chatbot utilizes the policy description, the available tools/actions, and access to a large language model to respond to a human in the example of FIG. 52. As an illustrative example, the Al's thought can include whether it needs to use a tool, whether it needs to ask a human a question for information, whether it needs to use a tool, observations on the results of use of tools, etc.

It will be understood in the previous examples of the autonomous AI chatbot agent, that it may leverage off previously described techniques for generating a granular taxonomy and determining an intent of a conversation. That is, it may be used in combinations and subcombinations with previously described examples.

### Automatically Building Workflow Policies

In some implementation, a workflow policy is automatically built based on an analysis of representative answers for a given intent. An AI model can be used to infer, from representative answers, a natural language workflow policy, tools/actions, and text responses used. That is, given historical support tickets and conversations, automation workflows can be built.

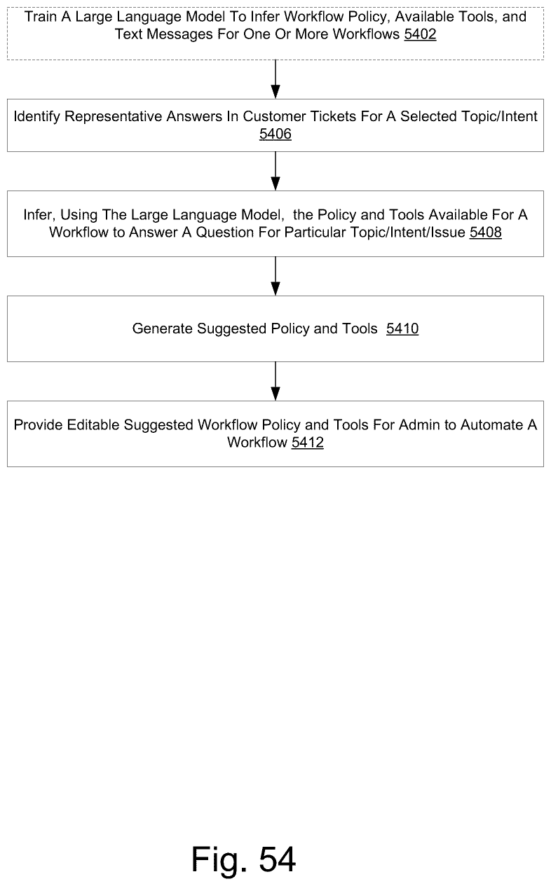

FIG. 54 illustrates a flowchart of a method of determining a natural language workflow policy in accordance with an implementation. In block 5402, a large language model is optionally trained to infer a workflow policy, available tools, and text message for one or more workflows. In block 5406, representative answers are identified in customer tickets for a selected topic/intent. In block 5408, the policy and tool available for a workflow are inferred using a large language model. In block 5410, a suggested natural language policy and tools are generated. In block 5412, this may be provided an editable and/or selectable form for an administrator to automate a workflow using, for example, a large language model as previously discussed.

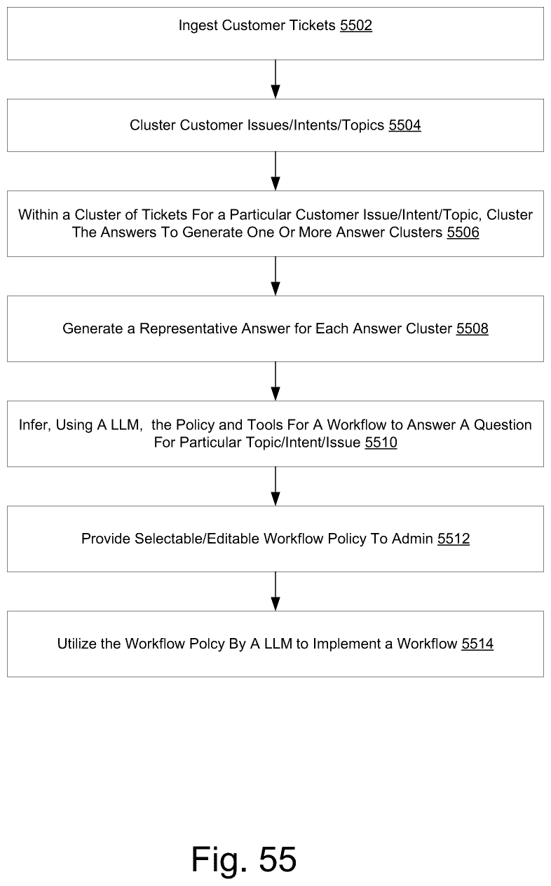

FIG. 55 illustrates another example of a flowchart of method of determining a natural language workflow policy in accordance with an implementation. In block 5502, customer tickets are ingested. In block 5505 clustering is performed to cluster the tickets based on issues/intent/topics as previously discussed in previous examples. In block 5506, with a cluster of ticket for a particular issue/intent/topic, the answers are clustered to generate one or more answer clusters. The answer clusters aid in detecting patterns of possible answer that human agents used in the past. In block 5508, a representative answer is generated for each answer cluster. In block 5510, a large language model is used to infer a natural language workflow to answer a question for a particular topic/intent/issue. This includes determining the available tools that may be used. In some implementations, includes determining text message for responding to certain instances. In block 5512 a selectable/editable workflow policy is provided to an admin to approve and/or tweak. In block 5514, the workflow policy is utilized by a large language model to implement a workflow.

In one implementation, the clustering technique that is used is a DBSCAN clustering technique that requires a min_points and a max_distance argument. In one implementation, the arguments are calibrated across many companies, based on intuition about a minimum number of occurrences for an answer to be considered its own case, and the distance below which suggest the answers as near duplicates; as well as simply “eyeballing” the results. In one example, these values are 15 for min_points and 0.1 for epsilon, although those values are particular to the encoder that is used. It would be understood that these values may vary depend on the encoder that is used, and other considerations. The output typically has couple of answer clusters per topic, generally 2-3, typically no more than 7, but sometimes 1. These answer clusters represent a percentage of the whole topic, which some of them contributing more than the others. However, a minimum requirement on size of percentage of the cluster (aside from the min_points argument) is not required.

As an illustrative example, consider, an issue about “returning an item.” In this example, it might be the case that there are two large clusters of answers corresponding to the following:
1—essentially telling the customer “this is how you return your item and you will receive a refund within 3 business days”
2—essentially telling the customer “sorry, since you purchased this item longer than 30 days ago, you cannot return it anymore”

In this example, the technique generates a representative answer for each of these answer clusters. These two representative answers are both fed to an AI model that infers the underlying policy that agents must have been following. The AI model in some implementation is a large language model, although more generally a custom AI model could be used to make the inference.

In this case for example, the workflow policy might be “Check whether the item was purchased within the last 30 days. If yes, give return instructions xyz. Otherwise, apologize because it's been longer than 30 days.”

Not only can this AI technique generate this inferred policy as natural language, but it can also detect any required API calls or actions needed to execute the policy. In some implementation, these would be placeholders that the support administrator is prompted to review, confirm, and make any necessary tweaks.

Once the generated workflow policies expressed as text, along with the required tools confirmed by the administrator, the autonomous agent described above can be used to carry out these conversations.

As an example consider an intent for “return request”. By analyzing representative customer tickets, in one implementation, the text of the policy description corresponding to:
“When a customer requests a return, first apologize for the inconvenience.
   Check if the order was marked as delivered in the system.
      If the order is marked as delivered:
         Ask the customer to confirm if there was a ““Missed Delivery”” notice left behind.
         Suggest checking behind plants/furniture on their porch, side door/gate, and with their manager/leasing office or neighbors to see if the order was delivered there instead.
         Confirm that you have their correct shipping address on file.”

More generally, the technique can be used to generate workflow policies for a many different types of customer ticket issues, such as an exchange request, cancel order, unable to get discount, return label request, wants to change order, color change request, wants to exchange scrubs, missing items, incorrect email, cancel order and refund, order out of stock, gift card not received, where in my order, request for invoice, wants to change size, double charged for order, overcharged, cancel order and reorder, return status, unhappy with product, cancellation request, etc.

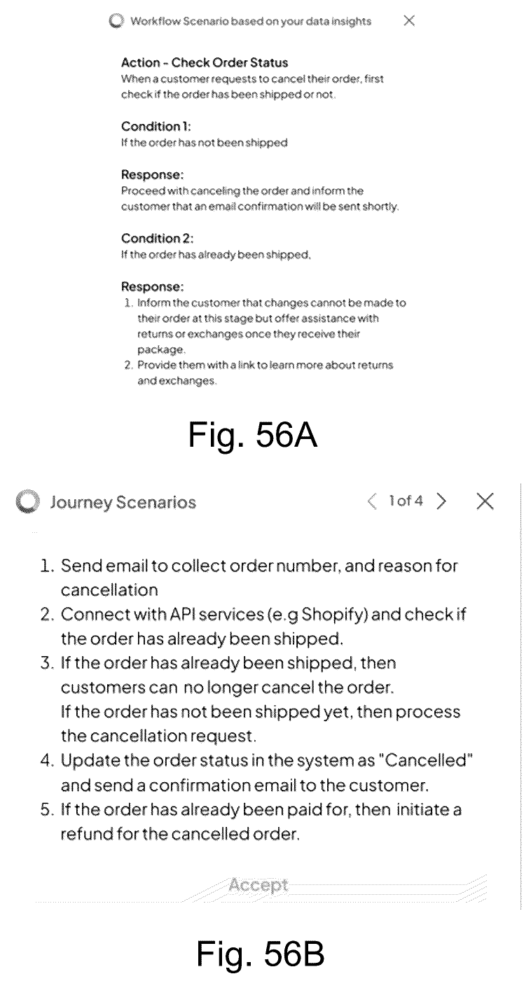

FIG. 56A and FIG. 56B illustrate examples of natural language workflow policies generated which may include, for example, actions, condition, and responses (FIG. 56A) or a set of descriptive natural language sentences (FIG. 56B).

### Alternate Embodiments

In the above description, for purposes of explanation, numerous specific details were set forth. It will be apparent, however, that the disclosed technologies can be practiced without any given subset of these specific details. In other instances, structures and devices are shown in block diagram form. For example, the disclosed technologies are described in some implementations above with reference to user interfaces and particular hardware. Moreover, the technologies disclosed above are primarily in the context of flash arrays. However, the disclosed technologies apply to other data storage devices.

Reference in the specification to “one embodiment”, “some embodiments” or “an embodiment” means that a particular feature, structure, or characteristic described in connection with the embodiment is included in at least some embodiments of the disclosed technologies. The appearances of the phrase “in some embodiments” in various places in the specification are not necessarily all referring to the same embodiment.

Some portions of the detailed descriptions above were presented in terms of processes and symbolic representations of operations on data bits within a computer memory. A process can generally be considered a self-consistent sequence of steps leading to a result. The steps may involve physical manipulations of physical quantities. These quantities take the form of electrical or magnetic signals capable of being stored, transferred, combined, compared, and otherwise manipulated. These signals may be referred to as being in the form of bits, values, elements, symbols, characters, terms, numbers, or the like.

These and similar terms can be associated with the appropriate physical quantities and can be considered labels applied to these quantities. Unless specifically stated otherwise as apparent from the prior discussion, it is appreciated that throughout the description, discussions utilizing terms, for example, “processing” or “computing” or “calculating” or “determining” or “displaying” or the like, may refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The disclosed technologies may also relate to an apparatus for performing the operations herein. This apparatus may be specially constructed for the required purposes, or it may include a general-purpose computer selectively activated or reconfigured by a computer program stored in the computer.

The disclosed technologies can take the form of an entirely hardware implementation, an entirely software implementation or an implementation containing both software and hardware elements. In some implementations, the technology is implemented in software, which includes, but is not limited to, firmware, resident software, microcode, etc.

Furthermore, the disclosed technologies can take the form of a computer program product accessible from a non-transitory computer-usable or computer-readable medium providing program code for use by, or in connection with, a computer or any instruction execution system. For the purposes of this description, a computer-usable or computer-readable medium can be any apparatus that can contain, store, communicate, propagate, or transport the program for use by or in connection with the instruction execution system, apparatus, or device.

A computing system or data processing system suitable for storing and/or executing program code will include at least one processor (e.g., a hardware processor) coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output or I/O devices (including, but not limited to, keyboards, displays, pointing devices, etc.) can be coupled to the system either directly or through intervening I/O controllers.

Network adapters may also be coupled to the system to enable the data processing system to become coupled to other data processing systems or remote printers or storage devices through intervening private or public networks. Modems, cable modems and Ethernet cards are just a few of the currently available types of network adapters.

Finally, the processes and displays presented herein may not be inherently related to any particular computer or other apparatus. Various general-purpose systems may be used with programs in accordance with the teachings herein, or it may prove convenient to construct a more specialized apparatus to perform the required method steps. The required structure for a variety of these systems will appear from the description below. In addition, the disclosed technologies were not described with reference to any particular programming language. It will be appreciated that a variety of programming languages may be used to implement the teachings of the technologies as described herein.

The foregoing description of the implementations of the present techniques and technologies has been presented for the purposes of illustration and description. It is not intended to be exhaustive or to limit the present techniques and technologies to the precise form disclosed. Many modifications and variations are possible in light of the above teaching. It is intended that the scope of the present techniques and technologies be limited not by this detailed description. The present techniques and technologies may be implemented in other specific forms without departing from the spirit or essential characteristics thereof. Likewise, the particular naming and division of the modules, routines, features, attributes, methodologies, and other aspects are not mandatory or significant, and the mechanisms that implement the present techniques and technologies or its features may have different names, divisions and/or formats. Furthermore, the modules, routines, features, attributes, methodologies, and other aspects of the present technology can be implemented as software, hardware, firmware or any combination of the three. Also, wherever a component, an example of which is a module, is implemented as software, the component can be implemented as a standalone program, as part of a larger program, as a plurality of separate programs, as a statically or dynamically linked library, as a kernel loadable module, as a device driver, and/or in every and any other way known now or in the future in computer programming. Additionally, the present techniques and technologies are in no way limited to implementation in any specific programming language, or for any specific operating system or environment. Accordingly, the disclosure of the present techniques and technologies is intended to be illustrative, but not limiting.

What is claimed is:

1. A method for responding to a customer service ticket comprising:
prompting a large language model with a natural language text description of a workflow policy, wherein the workflow policy is selected based on a topic of a customer support ticket to solve a specific customer issue;
prompting the large language model with conversation information regarding a conversation between a customer and an autonomous AI chatbot agent, wherein the conversation is associated with the customer support ticket for the specific customer issue;
prompting the large language model with information describing applicable actions to implement the workflow, including any applicable API calls; and
prompting the large language model with at least one text message for the workflow;
the large language model observing the results of actions of the workflow, making decisions on information to request from the customer, and making decisions on actions to take to implement the workflow.

2. An apparatus for responding to a customer service ticket comprising:
an autonomous AI chatbot agent utilizing a large language model to implement a workflow to solve a customer service support ticket;
the large language model being prompted with a natural language workflow policy and a description of available tools to generate an interactive workflow for interacting with a customer to solve the customer service support ticket.

3. The apparatus of claim 2, further comprising a software entity to determine the intent of the customer service support ticket and select a workflow policy for the determined intent.

4. The apparatus of claim 2, wherein the natural language workflow further comprises at least one action having an associated software tool.

5. The apparatus of claim 4, wherein the associated software tool includes an API call.

6. The apparatus of claim 2, wherein the natural language workflow includes at least one specified text message to respond to a particular instance of the workflow.

7. The apparatus of claim 2, wherein the autonomous AI chatbot agent interacts with the large language model.

8. The apparatus of claim 2, wherein autonomous the AI chatbot agent includes the large language model.

9. The apparatus of claim 2, wherein the workflow policy comprises at least one natural language sentence.

10. The apparatus of claim 2, wherein the large language model is prompted with conversation information associated with a customer ticket, prompted with the workflow policy, prompted with information on applicable software tools for the workflow policy.

11. The apparatus of claim 10, wherein the large language model is further prompted with guard rail prompts.

12. A method for responding to a customer service ticket comprising:
receiving a natural language text description of a workflow policy for a particular customer support topic;
determining a topic of a conversation between an autonomous AI chatbot agent respond to a customer service support ticket of a human being;
utilizing a large language model to implement a workflow to solve a customer service support ticket; and
prompting the large language model with the workflow policy and a description of available tools to generate an interactive workflow for interacting with the customer to solve the customer service support ticket.

13. The method of claim 12, further comprising utilizing a taxonomy generated for historic customer support tickets to generate a list of customer support tickets.

14. The method of claim 12, wherein the natural language workflow further comprises at least one action having an associated software tool.

15. The method of claim 14, wherein the associated software tool includes an API call.

16. The apparatus of claim 12, wherein the natural language workflow includes at least one specified text message to respond to a particular instance of the workflow.

17. The method of claim 12, wherein the autonomous AI chatbot agent interacts with the large language model.

18. The method of claim 12, wherein autonomous AI chatbot agent includes the large language model.

19. The method of claim 12, wherein the workflow policy comprises at least one natural language sentence.

20. The method of claim 12, wherein the large language model is prompted with conversation information associated with a customer ticket, prompted with the workflow policy, prompted with information on applicable software tools for the workflow policy.

21. The method of claim 20, wherein the large language model is further prompted with guard rail prompts.
